(19) United States
(12) Patent Application Publication
(10) Pub. No.: US 2026/0365362 A1
(43) Pub. Date: Nov. 19, 2026

(54) PACKAGING MACHINE AND LABELING DEVICE

(71) Applicant: Weber Food Technology SE & CO. KG, Breidenbach (DE)

(72) Inventors: Michael BRANDT, Eschenburg (DE); Christian DETERS, Bielefeld (DE); Stefan KRAKOW, Marburg (DE); Sebastian STRASEN, Werther (DE)

(21) Appl. No.: 19/477,993

(22) PCT Filed: Apr. 22, 2024
(86) PCT No.: PCT/EP2024/060866

§ 371 Date: Oct. 23, 2025

(30) Foreign Application Priority Data
Apr. 24, 2023 (DE) 10 2023 110 423.3
Jul. 10, 2023 (DE) 10 2023 118 226.9

(51) Int. Cl. B65C 9/18; B65C 1/02; B65C 9/36

(52) U.S. Cl. CPC B65C 9/1884; B65C 1/021; B65C 9/36

(57) ABSTRACT

A packaging machine for packaging food products comprises a transport device for moving a material web along a longitudinal direction and a labeling device for applying labels to the material web, wherein the labeling device has a label dispenser and an application device, which is movable along the longitudinal direction, for applying the labels to the material web, wherein the label dispenser is configured to transfer labels to be applied to the application device. The labeling device further has a drive that is configured to move the application device along the longitudinal direction, wherein the drive comprises a motor and is configured to move the application device relative to the motor along the longitudinal direction.

### RELATED APPLICATION

The present application is a national stage application under 35 U.S.C. § 371 of International Application No. PCT/EP2024/060866, filed 22 Apr. 2024, which claims priority from German Patent Application Nos. 10 2023 110 423.3, filed 24 Apr. 2023 and 10 2023 118 226.9, filed 10 Jul. 2023. The above-referenced applications are incorporated by reference.

### SUMMARY

The invention relates to a packaging machine for packaging food products, in particular food portions that comprise one or more slices cut off from a food product, wherein the packaging machine comprises a transport device that is configured to move a material web along a longitudinal direction in order to produce packages.

Such packaging machines can in particular be used to mechanically package food products transferred to the packaging machine in order to produce ready-to-sell packaging. For this purpose, packaging machines can, for example, form a part of a processing line in which the food products are, for example, first cut into slices by a slicing apparatus, in particular a so-called high-speed slicer, and food portions can be formed from the cut-off slices and are then transferred to the packaging machine and packaged by it.

To be able to package the food products, and in particular such food portions, and to be able to produce corresponding packages, the packaging machine can move a material web along a longitudinal direction and can have one or more work stations at which the material web is processed to successively produce the packages. In particular, the packaging machine can provide packaging spaces formed on or in the material web at a transfer station, onto or into which packaging spaces the food products to be packaged can be brought. For this purpose, the packaging machine can, for example, be configured as a deep-draw packaging machine and can have a molding station that is arranged upstream of the transfer station and that is configured to form depressions or recesses in the material web so that the food products can be inserted into the provided depressions, and packaged therein, at the transfer station. The depressions can then be sealed at a sealing station by a top material web fed from above in order to obtain closed packages. In addition, packages produced in the material web can be separated at a separating station arranged downstream of the sealing station. Furthermore, it is, for example, also possible to place food products on defined spaces of a planar material web, wherein in this case closed packages can also be producible by sealing a top material web fed from above by means of the packaging machine.

In addition to the work stations already mentioned, packaging machines can furthermore have a labeling station to apply labels to produced packages and to provide a consumer with, for example, a product type, a weight, a best-before date or other information relating to the package or the packaged food product. In this respect, a label is usually applied to both the upper side and the underside of a package. This usually takes place by connecting a labeling device to a suitable location of the packaging machine and by fastening it laterally to the packaging machine, for example.

However, when connecting such a so-to-say external unit—that is a specific and complex unit with respect to other functions of a packaging machine—, it is generally difficult to mutually coordinate the operation of the labeling device and the operation of the packaging machine so that the use of labeling devices can lead to operating disturbances or operating interruptions. Furthermore, as a rule, the connection of a labeling device to a packaging machine is also structurally complex since the connection of external units usually requires an unreasonably large installation space and the labeling devices can in particular extend laterally into a space next to the packaging machine, which space is, however, often required as a passage for the personnel operating the packaging machine. In addition, in particular in the case of a labeling device, the external attachment of movable elements of the labeling device to the packaging machine can be accompanied by inadequate access protection, which may again lead to operating disturbances and involves the risk of injury from crushing.

Furthermore, the above-mentioned difficulties with regard to labeling devices therefore in particular arise since both a labeling device for applying labels to an upper side of packages and a further labeling device for applying labels to an underside of the packages are often provided, wherein the labeling devices are usually applied to mutually oppositely disposed sides of the packaging machine. Personnel operating the packaging machine must therefore constantly switch between the sides of the packaging machine to be able to make adjustments to a respective labeling device so that such adjustments mean a high time effort and a poor integration or an incorrect operation of labeling devices can lead to considerable interruptions in the operation of a packaging machine or of a processing line comprising a packaging machine, and thus of the product throughput to be achieved.

It is therefore an object of the invention to provide packaging machines and labeling devices that enable a reliable operation with as high as possible an integration of the labeling devices into the packaging machine and/or into a processing line comprising the packaging machine.

This object is first satisfied by a packaging machine having the features of claim 1.

The packaging machine has a labeling device for applying labels to the material web, which labeling device has a label dispenser and an application device, which is movable along the longitudinal direction, for applying the labels to the material web, wherein the label dispenser is configured to transfer labels to be applied to the application device. Furthermore, the labeling device has a drive that is configured to move the application device along the longitudinal direction. The drive comprises a motor and is configured to move the application device relative to the motor along the longitudinal direction.

Since the packaging machine has the labeling device, the labeling device thus forms a component of the packaging machine and does not have to be attached to the packaging machine as an additional external add-on part that can optionally be attached, but, on the contrary, is so-to-say permanently integrated into the packaging machine. This integration enables an improved coordination between the operation of the labeling device and the operation of the further components of the packaging machine, wherein the labeling device can furthermore in particular be controllable by a control device of the packaging machine and/or a higher-ranking line control of a processing line that also controls the further components of the packaging machine. A complex communication between different control devices can in particular be avoided by such a common control so that cycle times of the packaging machine, which are, for instance, predefined by the central control device, can also directly apply to the labeling device. Furthermore, the integration of the labeling device into the packaging machine and in particular into its control also makes it possible to transmit data relating to the packages and/or the food products packaged therein to the labeling device in the simplest possible manner so that, for instance, information specifically tailored to a food product, for example a product weight, can be transmitted to a printer of the labeling device and can be printed on a corresponding label. In particular, the labeling device can for this purpose have a printer that is configured to print labels provided by the label dispenser before the transfer to the application device.

For example, the label dispenser can have a label store into which a label carrier tape rolled up into a roll can be insertable, on which label carrier tape the labels are, in particular in unprinted form, provided and/or adhesively bonded. The label carrier tape can be guided to a printer of the labeling device, in particular via a plurality of deflection and/or dancer rollers, so that the labels provided on the label carrier tape can be printed. The labels can then be transferred to the application device, for which purpose the labels can, for example, be guided over a transfer edge at which the label carrier tape can form a bend and the labels can be released from the label carrier tape.

The application device can, for example, have a housing in whose inner space a negative pressure can be generated by a vacuum device to be able to take over the labels released from the label carrier tape. Furthermore, the application device can, for example, have a plurality of revolving and drivable belts to be able to move the taken-over labels transversely to the longitudinal direction of the packaging machine and to be able to bring them into a provided position that is assigned to a package to be labeled. To be able to apply the labels to the material web, the application device can, for example, have a plurality of application elements, in particular movable pins, which can be moved perpendicular to a surface of extent of the labels and by which the labels can be released from the belt and brought into contact with the material web. The application of the labels to the material web can in particular take place by adhesive bonding.

In this regard, the application device can generally be configured to take over labels from the label dispenser and to orient them transversely to the longitudinal direction to be able to apply the labels to the material web at a provided location that is in particular defined in a transverse direction extending transversely to the longitudinal direction. Furthermore, the labeling device, however, has a drive by means of which the application device can be moved along the longitudinal direction so that a label to be applied can also be oriented in the longitudinal direction and can be applied precisely to the material web at a position defined in two dimensions. In addition, the packaging machine can in particular be configured to pre-draw the material web in cycles and, during a cycle, to provide a plurality of packages in rows spaced apart from one another in the longitudinal direction, wherein the labeling device can be configured to label the packages of all the rows during a cycle pause by applying labels. Therefore, the drive of the labeling device can, for example, also serve to move the application device from row to row during such an application of labels, and during the cycle pause in which the material web is stationary, to be able to label the rows of packages one after another.

In particular, the packaging machine can be configured to provide a format of packages, wherein the format can be formed by a matrix of packages arranged in m rows along the longitudinal direction and of packages disposed next to one another in n tracks in the longitudinal direction. The application device can be configured to simultaneously label packages in the n tracks in that a corresponding number of labels can be taken over from the label dispenser and can be brought into a corresponding position and/or track transversely to the longitudinal direction at the application device. During a cycle pause, the m rows of packages can therefore in particular be approached one after another and the packages located in a respective row can be labeled simultaneously. The parameters n and m can in particular be natural numbers greater than or equal to 1.

The drive for moving the application device in the longitudinal direction thus makes it possible to bring the labels to provided positions and, for example, to approach different rows of packages. Furthermore, the configuration of the drive for moving the application device relative to the motor also enables an improved, safer and accelerated operation since less mass must be moved compared to conventional solutions with external labeling devices. An advantage that can again be achieved primarily by the direct integration of the labeling device into the packaging machine.

Due to the external attachment of labeling devices to packaging machines in the prior art, drive concepts are usually pursued in which the motor for moving the application device is itself moved together with the application device, i.e. the application device cannot be moved relative to the motor along the longitudinal direction. In the packaging machine disclosed herein or its labeling device, the motor can, in contrast, in particular remain stationary during the movement of the application device so that the weight to be moved can be reduced compared to conventional solutions, which can, for example, enable a faster and more flexible movement of the application device in the longitudinal direction and can thus possibly reduce cycle times. In addition, due to the reduced weight to be moved, any vibrations during the movement of the application device can be reduced and more precise movements can be achieved. Furthermore, the movement of the application device is less sluggish with less weight, whereby a more flexible control of the application device and, for example, a braking in the travel path of the application device can be made possible in order, for instance, to be able to avoid injuries caused by crushing or damage to the application device.

It can generally be provided that the labeling device is configured to apply labels to packages that are provided by the packaging machine and that are formed in the material web. Therefore, the labeling device can in particular be arranged after a transfer station of the packaging machine and/or after a sealing station of the packaging machine in order to label the closed packages. Furthermore, the labeling device can be configured to label the packages at an upper side and/or at an underside. Therefore, the material web mentioned can in particular be a top material web that is fed from above and that closes the packages and/or a bottom material web which is fed from below and on which the food products rest. The material web can, for example, be configured as a film web, a paper web or a material web of an organic material.

Further embodiments are explained in the dependent claims, in the description, and in the Figures.

In some embodiments, the motor can be configured as a servomotor.

A servomotor for moving the application device can have an electric motor of generally any desired design having a rotor, for example a direct current motor, an asynchronous motor or a synchronous motor, and in particular comprises a measurement device that makes it possible to determine the exact position and/or the rotational position and/or the angle of rotation of the rotor at any time. In this respect, this position measurement can, for example, take place via a rotary encoder, for which purpose in particular a resolver, an incremental encoder or an attribute encoder can be provided.

Furthermore, the servomotor can in particular be a component of a servo drive for moving the application device as which the aforementioned drive can thus be configured. The servo drive can in particular comprise the servomotor and the servo inverter comprising power electronics and a power control. Such a servomotor can therefore enable a precise movement of the application device and a precise positioning of the labels in the longitudinal direction, wherein the servomotor can in particular be position-controlled, torque-controlled and/or speed-controlled.

In some embodiments, the motor can further extend along the longitudinal direction. Therefore, the motor can in particular be configured as narrow transversely to the longitudinal direction in order, for example, to be able to be laterally attached to a frame of the packaging machine (for example with a flange-mounted angular gear unit), without this involving a restriction of the access possibilities to the housing in the region of work stations or a widening of the packaging machine. Alternatively thereto, in some embodiments, the motor can extend in a vertical direction and can be configured to drive a motor shaft about a vertical motor axis. This, too, can enable a narrow configuration of the motor in the transverse direction, wherein a motor shaft rotating about a vertical motor axis can furthermore enable a simple driving of a belt revolving in a horizontal plane for driving the application device, as will be further explained below.

In some embodiments, the motor can be held in a stationary manner at a frame of the packaging machine.

In particular, the packaging machine can have a frame via which respective work stations of the packaging machine, for example a molding station, a sealing station and/or a separating station, are supported on the floor. Since the motor can be held in a stationary manner at the frame of the packaging machine, the application device can thus be movable relative to the support of the motor at the frame. In particular, the motor can be held laterally at the frame of the packaging machine.

In some embodiments, the application device can be guided by a guide device in order to move along the longitudinal direction, wherein the guide device can be arranged at the frame of the packaging machine.

In particular, the guide device can furthermore be supported at the frame so that the application device and/or the labeling device can also be supported at the frame of the packaging machine via the guide device. The guide device can be configured to guide the application device along the frame of the packaging machine so that the movement of the application device can take place precisely along the direction of extent of the packaging machine and its frame—i.e. in the longitudinal direction—without a lengthy orientation of the labeling device along this longitudinal direction having to take place during an attachment of an external labeling device.

In some embodiments, the guide device can have a guide rod which extends in the longitudinal direction and on which a carriage that can be moved by the motor can be guided, to which carriage the application device is connected. Once again, such a guide rod comprising a carriage makes it possible to easily align the movement of the application device with the longitudinal direction of the packaging machine.

In some embodiments, the guide rod can be arranged at a lateral beam of the frame of the packaging machine, said lateral beam extending in the longitudinal direction.

The beam of the frame can in particular be arranged laterally outwardly at the packaging machine and can extend as a longitudinal beam to support components of the packaging machine in the longitudinal direction. Furthermore, in some embodiments, the beam can have a casing and/or a casing of the packaging machine, for example composed of metal sheets, can be supported at the beam. In particular, an inner space bounded by the casing can be formed at the beam, through which inner space, for example, cables for supplying components of the packaging machine with electrical energy can be guidable and can be protected against access or against damage. Within the framework of the present disclosure, the part of a casing of the packaging machine, in particular a side casing, that is supported at the beam or a longitudinal beam of the frame of the packaging machine is understood as part of the beam so that in particular an inner space that is bounded by a casing and that extends in the longitudinal direction in the region of a longitudinal beam of a frame of a packaging machine and/or that is bounded in the direction of the material web by the longitudinal beam or the beam can also be referred to as the inner space of the beam in the present disclosure.

Since the guide rod can be arranged at the beam of the frame of the packaging machine, the guide rod can first be reliably supported at the frame of the packaging machine to also be able to support the application device at the frame. Furthermore, the guide rod can thereby be arranged laterally spaced apart from the material web, but, due to the attachment to the frame of the packaging machine, as close as possible to the material web. This can enable a compact integration of the labeling device and in particular of the application device into the packaging machine.

In some embodiments, the beam can, at an upper side, have an opening in which the guide rod is arranged. In particular, the opening can be formed at an upper side of the aforementioned casing of the packaging machine or of the beam.

Since the beam can have such an opening for arranging the guide rod, the carriage guided along the guide rod can be accessible at the upper side of the beam, in particular to be able to support the application device. Furthermore, the beam and/or the casing at the upper side—in particular in the working region of the labeling device—can be substantially closed apart from this opening in order, for example, to provide access protection for further components and/or cables guided in an inner space enclosed by the casing and/or the beam.

In some embodiments, the application device can be connected to the carriage above the opening.

For example, the application device can be arranged vertically in alignment with the material web to be able to apply labels to provided packages. To enable such an arrangement, a connection element, for instance a connection strut, can be supported at the upper side of the carriage, which is in particular guided at the lateral frame at the guide rod, by which connection element the spacing between the application device and the frame of the packaging machine can be bridgeable in the transverse direction and via which connection element the application device can be supportable at the carriage.

In particular, such a connection of the application device can be provided in a labeling device which is configured to label provided packages at an upper side and in which the application device is positioned above the material web. However, such an attachment of the application device can also be provided in labeling devices which are configured to label prepared packages at an underside and in which the application device is positioned below the material web. In such labeling devices, the application device positioned below the material web can be connected to the carriage at the upper side, in particular by a connection element that is guided laterally outwardly past the beam, starting from the application device, and that is guided back to the carriage at the upper side.

In some embodiments, the motor can be arranged in an inner space of the beam. In particular, the motor can be arranged in an inner space that is formed and/or bounded by a casing arranged at the beam. In particular, the motor can be at least substantially peripherally surrounded by the beam and/or the casing in order, as a result, to be reliably protected against access. Alternatively thereto, it can, for example, also be provided to integrate the motor into a vertical strut of a frame of the packaging machine, in particular on a vertical orientation of the motor.

In some embodiments, the motor can be connected to the carriage by a coupling element, in particular a belt, and can be configured to move the carriage by driving the coupling element. Such a coupling element, in particular a belt and/or a toothed belt, can thus make it possible to transmit drive power generated by the motor to the carriage and to move the carriage relative to the fixed-position motor to also be able to move the application device relative to the motor in the longitudinal direction.

The coupling element can be configured as a revolving belt in some embodiments. In particular, the belt can be interrupted and respective ends of the belt can be fastened, in particular clamped, to the carriage so that the carriage can so-to-say bridge the interruption of the belt.

The belt can further in particular be configured as a toothed belt and/or the coupling element can revolve along the longitudinal direction of the packaging machine. In particular, the coupling element can be guided via two deflection rollers that can rotate about a vertical axis of rotation. In some embodiments, the motor can furthermore be connected to the coupling element and/or a deflection roller via a crown gear to be able to drive the coupling element and, via the latter, the carriage and the application device. This, too, can enable a narrow configuration of the drive for the application device to be able to integrate the drive with as simple as possible a design into the packaging machine.

In some embodiments, the coupling element can be guided in an inner space of the beam. In particular, the coupling element can be guided in an inner space that is formed by a casing arranged at the beam. In this regard, the coupling element and in particular a revolving belt can also be protected against external access and can be integrated completely and in a compact manner into the packaging machine without, for instance, having to be placed at the outside onto the packaging machine.

In some embodiments, the guide rod can be arranged at a drive side of the labeling device at the packaging machine, wherein, in such embodiments, the guide device can have a further guide rod that extends along the longitudinal direction and that is arranged at a support side, which is opposite the drive side, at the packaging machine. Furthermore, the application device can be supported at the support side via a further carriage that is movable along the further guide rod.

The guide rod and the further guide rod can thus be spaced apart from one another transversely to the longitudinal direction in order to enable a support of the application device, which bridges the material web, via respective carriages at both sides. In particular, a force developed by the motor of the drive for moving the application device can first be transmitted to the carriage arranged at the guide rod and from the carriage to the application device that can in turn transmit the force to the carriage that is arranged at the further guide rod and that can therefore only be passively co-movable and can in this regard serve for the guidance of the application device, but not necessarily for the driving thereof. However, it is also possible for the labeling device to have a further motor to drive the carriage arranged at the further guide rod.

In some embodiments, the motor can be arranged at the drive side. In this regard, in some embodiments, the active components of the drive, in particular the motor, a coupling element and the carriage guided at the guide rod, can be arranged at the drive side.

In some embodiments, the further guide rod can be supported at the frame of the packaging machine. In this regard, the application device can also be supported at both sides at the frame of the packaging machine and the weight of the application device can be transferrable to the frame of the packaging machine.

In some embodiments, the frame of the packaging machine can have a respective outer beam, which extends along the longitudinal direction, at the drive side and at the support side and the packaging machine can comprise a chain guide for moving the material web. Furthermore, the guide rod can be arranged at the beam arranged at the drive side and the further guide rod can be arranged between the chain guide and the beam arranged at the support side. The chain guide can in particular be part of the transport device of the packaging machine and can be provided to move the material web along the longitudinal direction.

Due to such an arrangement, the beam arranged at the support side of the labeling device can thus be kept free in order, for example, to be able to support a guide device of a further labeling device thereat, the further guide rod of said guide device in turn being able to be attached at the opposite side between the chain guide and the beam arranged there. In this regard, the two labeling devices can so-to-say be supported in a mirrored manner at the frame of the packaging machine. In particular, this can make it possible to arrange a first labeling device for applying labels to an upper side of the provided packages and a second labeling device for applying labels to an underside of the provided packages at the packaging machine or to integrate said first and second labeling device into the packaging machine.

In some embodiments, the further guide rod can be arranged above the guide rod. In other embodiments, the further guide rod can be arranged below the guide rod.

In particular, in a labeling device for applying labels to an upper side of provided packages, it can be provided that the further guide rod is arranged above the guide rod. Due to such an arrangement of the further guide rod, the application device can in particular also be positioned above the material web.

In the case of labeling devices that are provided to apply labels to an underside of the provided packages, the further guide rod can, however, in particular be arranged below the guide rod, wherein the application device can also be positioned below the material web.

In some embodiments, the drive can be arranged at least substantially below a plane in which the material web is guided.

In particular, the motor and a coupling element, via which the motor is connected to a carriage for moving the application device, can be arranged completely below said plane. Furthermore, in some embodiments, the aforementioned guide rod can also be arranged below this plane. In some embodiments, a carriage connected to the application device can also be arranged below said plane, wherein, in other embodiments, in which the drive is arranged at least substantially below this plane, the carriage can, however, also project slightly beyond the plane. In particular, however, a large part of the movable elements of the drive can be arranged below an upper edge level of a casing of the packaging machine, in particular below a casing arranged at the mentioned beam and/or a section of a casing of the packaging machine and/or of the beam. Once again, this can in particular serve to protect access and thus to prevent injuries or interruptions of the operation.

In some embodiments, the label dispenser can be movable along the longitudinal direction together with the application device by the drive. In particular, in some embodiments, the entire labeling device can be movable along the longitudinal direction by the drive. Such a joint movement of the label dispenser and the application device can in particular ensure an always constant transfer of the labels to the application device, regardless of their position in the longitudinal direction.

In some embodiments, the application device can be arranged above the material web and can be configured to apply labels to the material web at an upper side of the material web. A labeling device comprising such an application device can therefore in particular also be referred to as a top labeler and/or can in particular be configured to apply labels to an upper side of provided packages.

Furthermore, in some embodiments, the application device can be arranged below the material web and can be configured to apply labels to the material web at an underside of the material web. A labeling device comprising such an application device can also be referred to as a bottom labeler and/or can in particular be configured to apply labels to an underside of provided packages.

In some embodiments, the packaging machine can be configured to move the material web in cycles and, in each cycle, to provide a format of a plurality of packages formed in the material web for a cycle pause, wherein the format can comprise a matrix of n tracks arranged parallel to the longitudinal direction and m rows arranged transversely, in particular perpendicular, to the longitudinal direction. In such embodiments, the application device can be configured to simultaneously label n packages arranged transversely, in particular perpendicular, to the longitudinal direction, wherein the drive can be configured, during the cycle pause, to move the application device successively to the m rows for labeling the respective n packages.

In such embodiments, the application device can therefore in particular be configured to pick up n labels together in order to be able to simultaneously apply them to the n packages arranged in a respective row. In this regard, the application device can therefore be configured to label a series of packages at the same time. After the labeling of a row, the drive can be used to move the application device to the subsequent row of packages, wherein, during the movement or after the movement, further labels can be transferred by the label dispenser to the application device, which further labels the application device can then apply in the row that has been moved to.

The variables m and n can in particular be natural numbers greater than or equal to 1. For example, the packaging machine can be configured to provide a format of three rows and three tracks and/or a format of three rows and four tracks and/or a format of four rows and three tracks during one cycle. Other formats are generally also possible, wherein the formats can, for example, be based on the respective food product to be packaged. In some embodiments, the packaging machine can further be retrofittable to be able to provide different formats, wherein, due to the integration of the labeling device into the packaging machine, the operation of the labeling device can also be easily adapted to such a format change, for example by a corresponding setting at a common control device.

In some embodiments, the packaging machine can have a first labeling device and a second labeling device, wherein the application device of the first labeling device can be arranged above the material web and can be configured to apply labels to an upper side of the material web, in particular an upper side of a top material web, wherein the application device of the second labeling device can be arranged below the material web and can be configured to apply labels to an underside of the material web, in particular an underside of a bottom material web.

In particular, in such embodiments, the packaging machine can be configured to move a bottom material web, onto which the food products can be placed, and a top material web, by which packages containing the food products can be closed, along the longitudinal direction. The application device of the first labeling device can be configured to apply labels to the top material web and the application device of the second labeling device can be configured to apply labels to the bottom material web.

In such a packaging machine, the provided packages can therefore be labeled at both the upper side and the underside in order to provide information about the packaged food product at both sides. As already explained, the first labeling device and the second labeling device can in particular so-to-say be arranged in a mirrored manner at the packaging machine and both the first labeling device and the second labeling device can have one or more of the above-explained features of the labeling device.

In some embodiments, the first labeling device and the second labeling device can have a respective drive comprising a motor for moving the respective application device, wherein the motor of the drive of the first labeling device can be held in a stationary manner at a frame of the packaging machine at a first side of the packaging machine and wherein the motor of the drive of the second labeling device can be held in a stationary manner at the frame at a second side of the packaging machine that is opposite the first side of the packaging machine.

In particular, the two labeling devices can thus be arranged opposite one another and/or so-to-say in a mirrored manner with respect to one another so that, for instance, the drive side of the first labeling device already mentioned above can form the support side of the second labeling device, and vice versa.

The invention furthermore relates to a labeling device for applying labels to a material web that is moved along a longitudinal direction by a packaging machine in order to produce packages for food products, in particular a labeling device of a packaging machine of the above-described kind. The labeling device has a label dispenser and an application device, which is movable along the longitudinal direction, for applying the labels to the material web, wherein the label dispenser is configured to transfer labels to be applied to the application device. The labeling device further has a drive that is configured to move the application device along the longitudinal direction, wherein the drive comprises a motor and is configured to move the application device relative to the motor along the longitudinal direction.

As already explained, the configuration of the labeling device with such a drive in particular makes it possible to move the application device without having to move the motor. As explained, due to the reduced weight to be moved, this can enable an easier, faster and better controllable movement of the application device and an improved integration of the labeling device into the packaging machine in that the motor can, for instance, be supported at a frame of the packaging machine and/or can be arranged in an inner space of a lateral beam of the frame.

The labeling device described can in particular have one or more of the further features that were explained above in connection with the labeling device integrated into a packaging machine. In particular, the motor can therefore be configured as a servomotor and/or the drive can have a belt that is driven via the motor and that is connected to a carriage on which the application device is supported. A configuration of the labeling device with guide rods and/or further guide rods, which can, for example, be inserted into a casing and/or a beam of a packaging machine, can also be provided.

The invention further relates to a labeling device for applying labels to a material web that is moved along a longitudinal direction by a packaging machine in order to produce packages for food products, in particular a labeling device according to any one of the embodiments disclosed. The labeling device has a label dispenser for providing the labels and an application device for applying the labels to the material web and the label dispenser is configured to transfer labels to be applied to the application device. Furthermore, the label dispenser has a label store, into which a label carrier tape rolled up into a roll can be inserted, on which label carrier tape the labels to be transferred to the application device are provided. The label store can in this respect be moved into a first position and into a second position that differs from the first position and is configured to transfer the labels to the application device both when the label store is positioned in the first position and when the label store is positioned in the second position.

The labeling device according to this aspect thus comprises a label store for a roll, which label store has two operating positions—the first position and the second position. In conventional labeling devices, such a movability of the label store can also generally be provided, for example, to enable a change of the roll in a more accessible position if, for instance, a label carrier tape has been used up or different types of labels are required. However, with such labeling devices, it has always been necessary until now to first move the label store from such a change position back into a working position different therefrom since a transfer of labels to the application device could only take place in the working position.

However, such a necessity for moving the label store to change the roll or to transfer labels to the application device can lead to unwanted disturbances and interruptions in the operation of the packaging machine if, for instance, the movement of the label store into the working position is forgotten after a roll change. This problem can moreover be made more difficult in that, in packaging machines that have a labeling device for labeling provided packages at the upper side and a further labeling device for labeling the packages at an underside, the respective label dispensers are usually arranged at opposite sides of the packaging machine so that a switch must be made between the sides of the packaging machine to operate a respective labeling device. The correction of a fault at one of the labeling devices—for instance, an incorrect positioning of the label store or a change of printer consumables—can therefore possibly require a change of the side of the packaging machine, which is associated with an undesirably high loss of time. Thus, as simple and as error-proof as possible a handling of the labeling devices should generally be striven for.

However, since the label dispenser of the labeling device explained above is configured to transfer the labels to the application device both in the first position and in the second position of the label store, this problem can be addressed. With regard to the operation of the labeling device, the first position and the second position can thus be understood as equivalent and the operation of the labeling device can take place regardless of the position of the label store. A roll change can hereby, for example, take place in a position of the label store that is as comfortable as possible for a person operating the labeling device and can, for example, remain unchanged during a shift without the label store having to be moved for the operation of the labeling device and/or for a subsequent roll change.

For example, the label store can have a mandrel onto which the roll is pluggable.

In some embodiments, the roll can be replaceable with a new roll of a rolled-up label carrier tape both in the first position of the label dispenser and in the second position of the label dispenser. In this regard, the first position and the second position can be completely equivalent in such embodiments in that the full functionality of the label dispenser can be available in each of the two positions.

In some embodiments, the label dispenser can be arranged higher in the first position than in the second position. In particular, the first position can therefore make it possible to arrange the label dispenser as far as possible outside a lateral region of a packaging machine in which the labeling device or persons operating the packaging machine have to move. Furthermore, the first position can enable a comfortable roll change for relatively tall persons.

In some embodiments, the first position and the second position can represent respective end positions with respect to a movability of the label dispenser that can be movable between the first position and the second position.

Furthermore, in some of these embodiments, the label dispenser can be configured to transfer the labels to the application device in each position of the label store between the first position and the second position. In such embodiments, a person operating the labeling device can thus select a position of the label store that is suitable for this person between the first position and the second position in order, for example, to be able to comfortably change rolls without having to change the position during the operation.

In some embodiments, steps can furthermore be provided between the first position and the second position, said steps defining respective intermediate positions in which the labels can be transferred to the application device. For example, the label store can latch in in such intermediate positions.

In some embodiments, in the second position, the label store can be further away from the application device in the horizontal direction than in the first position. In particular, in the second position, the label store can therefore project further into a space to the side of the labeling device or a packaging machine.

In principle, the second position can therefore enable a comfortable change of the roll since this change can take place spaced apart from the packaging machine and/or in a lower position compared to the first position. However, depending on the respective conditions—for example, if there is sufficient space at the side of the packaging machine—, it does not have to be necessary to move the label store out of this comfortable change position in order not to disrupt the operation of the packaging machine. In such a situation, the labeling device therefore makes it possible to leave the label store in the comfortably accessible second position while the labeling device is operated to apply labels.

In some embodiments, the label store can be pivotable between the first position and the second position, in particular about a horizontal pivot axis.

In some embodiments, the label dispenser can have a pivotable holding arm, wherein the label dispenser can be movable between the first position and the second position by pivoting the holding arm. The label dispensers can in particular be arranged at one end of the holding arm. Furthermore, in some embodiments, the holding arm can have a handle for moving the label store.

In some embodiments, the label carrier tape can be guidable to the application device via a plurality of deflection and/or dancer rollers. In particular, a guidance of the label carrier tape via such deflection and/or dancer rollers can make it possible to compensate for differences in the tape guidance during a positioning of the label store in the first position or during a positioning of the label store in the second position to be able to achieve a controlled transfer to the application device in each of the positions. Furthermore, in some embodiments, the labeling device can have a printer for printing labels provided on the label carrier tape, wherein the guidance via deflection and/or dancer rollers, for example also independently of the position of the label store, can ensure a correct positioning of the labels guided on the label carrier tape and/or a correct tensioning of the label carrier tape in the region of the printer.

The invention furthermore relates to a packaging machine for packaging food products, in particular food portions that comprise one or more slices cut off from a food product, said packaging machine comprising a transport device, which is configured to move a material web along a longitudinal direction in order to produce packages, and a labeling device in which a label store, as disclosed above, can be moved between a first position and a second position different therefrom and is configured to transfer labels to an application device in both positions. The application device of the labeling device of the packaging machine can furthermore in particular be movable along the longitudinal direction.

The invention also relates to a labeling device for applying labels to a material web that is moved along a longitudinal direction by a packaging machine in order to produce packages for food products, wherein this labeling device is in particular a labeling device of the kind disclosed above, which has a drive for moving an application device relative to a motor of the drive, and/or a labeling device of the kind disclosed above in which a label store can be arranged in two positions and can transfer labels in two positions to the application device. The labeling device according to this aspect further comprises a label dispenser for providing labels and an application device for applying the labels to the material web, wherein the label dispenser is configured to provide the labels on a label carrier tape and to transfer the provided labels to the application device. The application device has a vacuum device that is configured to generate a negative pressure in an inner space of the application device for sucking the provided labels onto a working side of the application device, wherein the vacuum device is furthermore configured to vary a strength of the negative pressure generated in the inner space spatially and/or temporally.

As already initially explained, provision can be made with a labeling device to provide labels on a label carrier tape and to guide them through the label dispenser over a transfer edge in order to release the labels from the label carrier tape and to transfer them to the application device. So that the labels released from the label carrier tape can be safely taken over by the application device, a negative pressure can be generated in an inner space of the application device, which inner space can in particular be bounded by a housing, so that the labels can be sucked onto the application device, and in particular its working side, and can thereby be stabilized. Then, the labels can, for example, be moved by means of the application device transversely to the longitudinal direction, along which the packaging machine moves the material web, into a respective position from which the labels can be applied to the material web and in particular to provided packages. In particular in an application device that is configured to apply the labels to the material web from above, the labels can thus so-to-say be moved upside down by this suction to a respective position, starting from which the labels are then lowered and applied to the material web. In the case of an application device that labels the provided packages from below, a stable positioning and a stable transport of the taken-over labels can likewise be achieved due to the generated negative pressure.

Conventionally, in such application devices, a constant negative pressure is generated by a fan or a suction device at an outer wall of a housing to be able to provide the functions mentioned.

Since the vacuum device of the labeling device described here is, however, configured to vary a strength of the negative pressure generated in the inner space spatially and/or temporally, the generated negative pressure can be intentionally adapted to certain operating situations, to certain sections of the application device or to a respective type of label to be able to achieve a more flexible and improved use of the labeling device.

For example, the vacuum device can have one or more fans to generate the negative pressure in the inner space. Furthermore, the labeling device can have a control device for the vacuum device that can be configured to vary a strength of the air flows generated by the fans and, as a result, the negative pressure prevailing in the inner space. This can make it possible, for example, to increase the negative pressure when taking over labels and to intentionally reduce it when dispensing the labels or when applying the labels to the material web in order to facilitate this application. Furthermore, it can be provided to arrange a larger number of fans or suction devices and/or more powerful fans or suction devices at a takeover section of the application device in which the labels are taken over from the label dispenser to be able to achieve a reliable takeover of the labels and/or to be able to support the release of the labels from the label carrier tape. In addition, a variation in the strength of the generated negative pressure, in particular a spatial variation, can be achieved by guide elements positioned in the inner space for guiding an air flow generated by the vacuum device, as will be explained in more detail below.

In some embodiments, the label dispenser can be configured to guide the label carrier tape over a transfer edge in order to transfer the labels to the application device, wherein the labels can be releasable from the label carrier tape by guiding the label carrier tape over the transfer edge. In particular, the label carrier tape can be guided over a sharp bend at the transfer edge so that the labels can be released from the label carrier tape due to their stiffness. The application device can in particular directly adjoin the transfer edge to be able to take over the released labels.

In some embodiments, the vacuum device can have at least one fan whose suction side is disposed in the inner space of the application device and whose pressure side is disposed outside the inner space of the application device. Such a fan can therefore act as a suction device with respect to the inner space of the application device. Furthermore, the fan can in particular have a ventilator at an outer wall of a housing of the application device, said ventilator being configured to generate an air flow directed out of the housing. In addition, in some embodiments, the vacuum device can have a plurality of such fans, for example two fans.

In some embodiments, at least one guide element for intentionally guiding an air flow generated by the fan in the inner space can be arranged in the inner space of the application device and/or in a region of the suction side of the fan.

In particular, such a guidance of the air flow can be used to locally intentionally increase the negative pressure generated in the inner space of the application device in that, for example, the air flow generated by a fan is guided into a specific section of the application device and in particular into the aforementioned takeover section for transferring the labels from the label dispenser. Furthermore, due to such a guide element, it can, for example, be achieved that an air flow within the inner space at the working side of the application device is oriented at least substantially perpendicular to a plane of extent of the working side to be able to suck the labels perpendicular to the working side and, as a result, to be able to stably guide them at the application device.

The guide element and/or at least a part thereof can be movable in some embodiments.

For example, such a movable guide element can be configured as a flap, as a pivotable intake nozzle and/or intake hose or as a secondary air opening that can be selectively opened or closed. Such a movable guide element can in particular be at least presettable and/or adjustable to be able to define a guidance of the air flow generated by the fan before the start of operation. In some embodiments, however, it is also possible to adjust the at least one guide element during the operation in order, by moving the guide element, to be able to achieve both a spatial and a temporal variation of the negative pressure, in particular in dependence on and/or in conjunction with a respective current operating state of the labeling device and/or the application device. For example, a control device of the labeling device can be configured to move the at least one guide element.

In some embodiments, the guide element can be arranged to deflect an air flow generated by the fan such that the air flow at the working side of the application device is oriented substantially perpendicular to a surface of extent of the labels. As already explained, such a deflection of the air flow can enable a stable holding of the labels at the working side of the application device in that the labels can be held at the working side by a force oriented perpendicular to their surface of extent.

In some embodiments, the inner space can be divided into at least two chambers by the guide element, wherein the strength of the negative pressure generated by the vacuum device in the chambers can differ. In particular, the inner space of the application device can be divided into chambers or zones by such a guide element, wherein the respective negative pressure in the chambers or zones can differ, for example, in dependence on fan positions at the housing of the application device and/or in dependence on a respective size of the chambers. In particular, such chambers can also be referred to as chutes.

For example, in some embodiments, the vacuum device can comprise two fans that are arranged at an outer side of a housing of the application device, wherein the guide element can divide the inner space of the application device into a relatively larger chamber and a relatively smaller chamber, wherein each of the chambers can be associated with a respective fan. It can hereby be achieved that, on an operation of the fans with the same power, a greater negative pressure is generated in the relatively smaller chamber than in the relatively larger chamber since only a smaller area at the working side needs to be acted on by the fan in the relatively smaller chamber. To enable such a division into chambers, the guide element can be configured as a wall element or a separating element, for example. Furthermore, in some embodiments, a plurality of such guide elements can also be provided and/or the inner space of the application element can be divided into more than two chambers. In addition, the guide element can, for example, be configured as a screen, for example as a perforated screen and/or as a perforated metal sheet, to be able to influence an air flow generated by the fan and to be able to set a resistance against it locally, for example.

In some embodiments, the labeling device can have a control device that is configured to control the vacuum device to change the strength of the generated negative pressure.

In particular, such a control device can make it possible to vary the negative pressure temporally, for example, by increasing the strength of the negative pressure during a takeover of labels from the label dispenser and then reducing it during the application of the labels to the material web. Due to such a time control, improvements with respect to a precise application of labels to the packages can be achieved, for example.

Furthermore, in some embodiments, the control device can be configured to control the vacuum device in dependence on a type and/or size of the labels. For example, it can be provided to control the vacuum device to generate a stronger negative pressure if relatively large and therefore heavy labels are to be applied to the material web and are therefore provided by the label dispenser, whereas the strength of the generated negative pressure can, for example, be reduced when taking over relatively light labels.

In some embodiments, the vacuum device can have a plurality of fans for generating the negative pressure and the control device can be configured to individually control the fans to change an air flow generated by the respective fan. The negative pressure prevailing in the inner space can also be varied spatially and/or temporally by such a control. The explained control of the respective fans can in particular also take place by switching the fans on and off so that the fans in such embodiments cannot necessarily be configured to generate variable air flows, but can at least be configured for a variable switching on and off. In other embodiments, however, a variable setting of the fans can also be provided with regard to the respective strength of the generated air flow.

In some embodiments, the control device can be configured to control the vacuum device to increase the strength of the negative pressure on a taking over of labels and/or to reduce the strength of the negative pressure on an application of the labels to the material web. As already explained, this can, for example, take place by switching on a fan on a takeover of the labels and/or switching off the fan on or after an application of the labels to the material web.

In some embodiments, the vacuum device can be configured to generate an increased negative pressure in a takeover section of the application device, said takeover section facing the transfer edge. In particular, the vacuum device can be configured to generate an air flow directed locally to the takeover section and extending over the full label width, label carrier tape width and/or transfer edge width in order to generate an increased negative pressure at the takeover section. Furthermore, in some embodiments, the vacuum device can have a fan, which is arranged directly at the takeover section, for generating a negative pressure in order, through a suction that is as close as possible to the labels to be taken over and/or that have just been taken over, to be able to achieve a reliable takeover of the labels from the label dispenser.

In some embodiments, the vacuum device can therefore have at least one fan arranged in the takeover section for generating the increased negative pressure. In particular, in some embodiments, two such fans can be arranged in the takeover section to be able to generate a suction flow for sucking in the labels close to the taken-over labels and over the full label width, label carrier tape width or transfer edge width.

In some embodiments, a separating element can be arranged in the inner space of the application device and prevents an exchange of air between the takeover section and an application section of the application device, said application section adjoining the takeover section. In this regard, the inner space of the application device can be divided into two chambers or pressure zones in such embodiments to be able to intentionally generate a respective negative pressure in the takeover section and in the application section. Furthermore, the fan arranged in the takeover section can in particular be arranged directly above the labels to be taken over and/or at an underside of a housing of the application device, whereas fans arranged in the application section can in particular be arranged at an outer wall and/or at a roof section of a housing of the application device.

In some embodiments, at least one further fan for generating a negative pressure can be arranged in the application section. This fan can in particular be understood as the main fan that can be provided to generate an air flow over a large area and/or relatively far away from the labels in order to generate a negative pressure. For example, such a housing can be arranged at a roof section of a housing of the application device. Conventional embodiments of labeling devices can therefore only have such fans at an outer side of a housing of the application device.

In some embodiments, the application device can have a plurality of application elements that can be moved substantially perpendicular to a surface of extent of the taken-over labels, wherein, by moving the application elements, the taken-over labels can be applicable to the material web, and wherein the application elements can be arranged in the inner space of the application device.

In particular, such application elements can be substantially vertically movable as pins or metal sheets and/or can in particular be arranged at the already mentioned application section. The application elements can furthermore in particular be configured as yielding in order, for example, to be able to yield on a pressing of the labels onto the material web and to be able to limit the pressure on the material web that is developed during the pressing on. For this purpose, the application elements can, for example, be designed as resilient, can be resiliently supported and/or can be supported via springs at a drive for moving the application elements.

In some embodiments, the application device can have a plurality of belts, which are movable transversely to the longitudinal direction, for moving the taken-over labels, wherein the application elements can be configured, in order to apply the labels to the material web, to engage between belts that are disposed next to one another and spaced apart from one another. In particular, the belts can thus be movable transversely to the longitudinal direction along which the packaging machine moves the material web to be able to position the labels transversely to this longitudinal direction.

In some embodiments, it can furthermore be provided that the vacuum device has at least one fan whose suction side is disposed within the inner space of the application device and whose pressure side is disposed outside the inner space of the application device, wherein the pressure side of the fan can be connected to a section of the inner space in order, at this section, to influence the negative pressure generated by the vacuum device. For example, provision can be made that the air flow generated by the fan and leading out of the inner space is intentionally guided past an outer side of a housing of the application device and past a housing opening. This can make it possible to suck air out of the inner space due to the Venturi effect and, as a result, to increase the negative pressure locally. In particular, such a connection can therefore be provided from the pressure side of a fan to a housing opening in the region of the aforementioned takeover section to be able to intentionally increase the negative pressure in the region of the takeover section. Due to such a use also of the pressure side of the fan to generate a negative pressure, the efficiency of the vacuum device can be increased. The connection between the pressure side and the housing opening can, for example, be producible by a hose.

The invention also relates to a packaging machine for packaging food products, in particular food portions that comprise one or more slices cut off from a food product, said packaging machine comprising a transport device that is configured to move a material web along a longitudinal direction in order to produce packages, and having a labeling device of the kind disclosed above comprising a vacuum device for generating a variable negative pressure in an inner space of an application device.

The invention furthermore relates to a labeling device for applying labels to a material web, which labeling device is moved along a longitudinal direction by a packaging machine in order to produce packages for food products. The labeling device can in particular be configured according to any one of the embodiments described above, i.e., for example, having a fixed-position motor of a drive for moving an application device, having a label store that can be moved into two positions with the full functionality of the labeling device regardless of the position of the label store and/or having a vacuum device for generating a variable negative pressure in an inner space of an application device.

The labeling device has a label dispenser for providing the labels and an application device for applying the labels to the material web, wherein the label dispenser is configured to transfer labels to be applied to the application device. The application device has a plurality of application elements that are arranged in a housing and that can be moved substantially perpendicular to a surface of extent of the labels transferred by the label dispenser, wherein, by moving the application elements, the labels can be released from the application device and can be applied to the material web. The application device furthermore has a drive for moving the application elements, wherein this drive comprises a servomotor.

In particular, the movement of the application elements can be a movement in a vertical direction to be able to release the labels from the application device and to be able to apply them to the application elements. Since the movement of the application elements in this respect takes place by means of a servomotor, a precise movement of the application elements can be achieved and, for example, a position regulation or a torque regulation can take place in order, for instance, to be able to vary a force with which the application elements press the labels on the material web and thus to be able to flexibly react to different label types and/or material web types.

In some embodiments, the servomotor can be arranged at an outer side of the housing of the application device. In this regard, the servomotor can be arranged outside the housing in order not to have to take up any installation space in the inner space of the housing in which the application elements are arranged. However, the servomotor can be connected to the application elements via a coupling element leading into the housing and/or a motor shaft of the servomotor can project into the housing to be able to drive the application elements arranged in the inner space.

In some embodiments, the application elements can be arranged at a carriage, wherein the carriage can be guided on at least one guide rod arranged in the housing and can be drivable by the servomotor.

In particular, two guide rods can be arranged in the housing in order to guide the carriage and, via the latter, the application elements in a stable manner during the movement for applying the labels. As already explained, the movement of the application elements can in particular be a vertical movement so that the guide rods can also extend in a vertical direction.

In some embodiments, the motor arranged at the outside at the housing can be connected to the carriage via a gear. This gear can in particular comprise a belt and/or a toothed belt that can be driven by the motor. In this respect, the belt can in particular be arranged within the housing or outside the housing that bounds the inner space of the application device. Furthermore, the belt can in particular be driven by a motor shaft of the servomotor extending into the housing and/or by a crown gear connected to the motor shaft.

In some embodiments, the application device can have a plurality of belts, which are movable transversely to the longitudinal direction, for moving the labels, wherein the application elements can be configured to engage between belts that are disposed next to one another and that are offset from one another.

Furthermore, the application elements can be arranged at a plurality of metal sheets offset in parallel from one another in the longitudinal direction and can be connected to said metal sheets by a respective latching connection, wherein, to form the latching connection, in particular a respective contour in the region of end faces of the metal sheets, said end faces facing the application elements, can be assigned to a respective contour of the application elements that is arranged at a section of the respective application element facing the metal sheets. The metal sheets can further be fastened to the carriage and can be movable by it. Furthermore, the metal sheets can be arranged such that respective application elements attached to the metal sheets can reach between respective belts disposed next to one another. In such embodiments, a respective plurality of application elements offset from one another in the transverse direction can furthermore be arranged at each of the metal sheets to be able to simultaneously apply labels to the material web that are offset from one another transversely to the longitudinal direction of the packaging machine.

The invention further relates to a labeling device for applying labels to a material web that is moved along a longitudinal direction by a packaging machine in order to produce packages for food products. This labeling device can also in particular be configured according to any one of the embodiments disclosed above, i.e. can, for example, have a fixed-position motor for moving an application device in the longitudinal direction, a label store that can be positioned in two equivalent positions, a vacuum device for generating a variable negative pressure in an inner space of an application device and/or an application device having a servomotor attached to the outside of a housing for moving application elements.

The labeling device has a label dispenser for providing the labels and an application device for applying the labels to the material web, wherein the label store is configured to transfer labels to be applied to the application device. The application device has a plurality of belts, which are movable transversely to the longitudinal direction, for moving the labels and a drive for moving the belts, wherein the drive comprises a servomotor.

Once again, the configuration of the drive with a servomotor makes it possible to precisely control and/or regulate the belts for moving the labels in order to enable a precise positioning of the labels.

In some embodiments, the servomotor can be arranged in a housing of the application device. In particular, the drive can in this respect be arranged in a housing of the application device in which the application elements already mentioned above for applying the labels to the material web can also be located.

In some embodiments, the servomotor can be arranged at an end section of the housing, said end section being opposite a takeover section of the application device, at which takeover section the labels provided by the label dispenser can be transferred to the application device. In this regard, the servomotor for driving the belts can be arranged in the housing such that the servomotor does not take up any installation space in the region of the takeover section. Instead, this installation space remains free of the servomotor and/or the drive and can therefore be used, for example, to attach additional fans for generating an intentionally increased negative pressure at the takeover section.

In some embodiments, the servomotor can be connected via a toothed belt to a shaft driving the belts. The servomotor can hereby be arranged spaced apart from the shaft to be able to arrange the servomotor flexibly, taking into account the respective space conditions in the inner space of the application device or its housing.

In some embodiments, the servomotor can be oriented in the longitudinal direction. As explained, the longitudinal direction within the framework of the present disclosure generally relates to the packaging machine and refers to the direction along which the material web is moved by the packaging machine. In relation to the application device itself, the longitudinal direction mentioned here can therefore correspond to a transverse direction of the application device since the application device may have a maximum extent transverse to the longitudinal direction of the packaging machine to be able to bridge the packaging machine and in particular the material web in the transverse direction (with respect to the packaging machine). Such an arrangement of the servomotor makes it possible to arrange the servomotor with a small space requirement in the transverse direction (in relation to the packaging machine) to be able to achieve a narrow configuration of the application device and prevent the application device from projecting laterally, in particular far, beyond a frame of the packaging machine.

In some embodiments, the shaft for driving the belts can be aligned in parallel with the servomotor and/or a motor shaft of the servomotor. The servomotor can be configured to drive the toothed belt via a crown gear and/or the toothed belt can be connected to one end of the shaft in order to drive the belts using the shaft. Such a drive can be realized in a simple manner.

In some embodiments, a plurality of application elements can further be arranged in the housing and are movable substantially perpendicular to a surface of extent of the labels transferred by the label dispenser, wherein the labels can, by moving, in particular vertically moving, the application elements, be releasable from the application device and can be applicable to the material web.

The invention further relates to a packaging machine for packaging food products, in particular food portions that comprise one or more slices cut off from a food product, said packaging machine comprising a transport device that is configured to move a material web along a longitudinal direction in order to produce packages. Furthermore, the packaging machine comprises a labeling device of the kind explained above in which a servomotor for moving application elements of an application device and/or a servomotor for moving belts of the application device for moving the labels is/are provided.

The invention furthermore relates to a packaging machine for packaging food products, in particular food portions that comprise one or more slices cut off from a food product, said packaging machine comprising a transport device that is configured to move a material web along a longitudinal direction in order to produce packages, and a labeling device for applying labels to the material web. In this respect, the labeling device can in particular be configured according to any one of the embodiments disclosed above, i.e. it can have, for example, a fixed-position motor for driving an application device, a label store that can be positioned in two equivalent positions, a vacuum device for generating a variable negative pressure in an inner space of the application device and/or an application device comprising a servomotor for moving application elements and/or for moving belts moving the labels.

The labeling device further has a label dispenser and an application device for applying labels located in a working region of the application device to the material web, wherein the label dispenser is configured to transfer labels to be applied to the application device. The application device is configured to selectively apply labels received from the label dispenser to the material web or to transfer said labels to a sorting-out element.

For example, the application device can be configured to apply the received labels selectively to the material web or to the sorting-out element and thus to apply them, in particular adhesively bond them, either to the material web or to the sorting-out element. In particular, it can be provided that the application device is configured to apply defective labels to the sorting-out element or to transfer them to the sorting-out element so that such defective labels are not applied to the package.

In conventional packaging machines, all the labels transferred from the label dispenser to the application device are applied to the material web, and in particular to respective packages, so that incorrectly labeled packages must be completely sorted out after the labels have been identified as defective, for example, in the course of a final inspection. However, this is obviously accompanied by an undesirably high material consumption and product waste. Furthermore, misprints can at most be manually collected by hand with a short feed pulse by the operating personnel at the application device.

Since the application device according to the labeling device explained here is, however, configured to selectively apply labels to a sorting-out element or to transfer them to the sorting-out element, in particular such defective labels cannot be applied to a package in the first place, but can already be sorted out beforehand. The material consumption of the packaging machine and in particular a waste of ready-to-sell packages can hereby be reduced.

In some embodiments, the sorting-out element can be arranged in a stationary manner at the packaging machine and in particular bridging the material web transversely to the longitudinal direction. Furthermore, in such embodiments, the application device can be movable relative to the sorting-out element.

In particular, this movement of the application device can take place by a drive by means of which the application device can be moved in the longitudinal direction. Such a movement can make it possible to selectively arrange the application device in alignment with the material web or in alignment with the sorting-out element to be able to selectively apply the labels to the material web or to the sorting-out element and, as a result, to be able to sort out in particular defective labels.

In such embodiments, the sorting-out element can furthermore in particular extend in a flat manner and/or at a small spacing from the material web so that the application of the labels to the material web, on the one hand, or to the sorting-out element, on the other hand, can take place in an almost identical manner and by an almost identical movement of application elements for applying the labels. As already explained, the application elements can furthermore in particular be spring-loaded and/or yieldingly supported to be able to compensate for a slight difference with respect to the distances to be covered for the respective application of the labels when the labels are applied to the material web or the sorting-out element. Furthermore, a sorting-out element attached directly above the material web can be easily traversed by components of the packaging machine in the longitudinal direction without the component having to be raised or lifted off.

In some embodiments, the sorting-out element can further be supported at the packaging machine and can be selectively movable into the working region of the application device. Such a sorting-out element can, for example, be configured as a slider or as a metal sheet that can be pivoted in.

In some embodiments, the sorting-out element can also be arranged extending in the longitudinal direction at an outer side of the packaging machine. In this regard, the sorting-out element can so-to-say be arranged at a margin of the working region of the application device at the packaging machine, wherein the position at the margin of the working region of the application device can only be approached to transfer labels to the sorting-out element. Therefore, for example, defective labels can be moved by the application device into the outermost region of the working region of the application device that can in particular be opposite a takeover section for taking over the labels to be able to transfer such defective labels to the sorting-out element.

In some embodiments, the sorting-out element can furthermore comprise a sorting-out web that can be wound up, in particular a film, that is supported at the packaging machine. In particular, such a sorting-out web and/or film can extend between the material web, in which the packages are produced, and the application device and/or on a base or a support surface as a counter-pressure element to be able to selectively apply labels to such a sorting-out element. The sorting-out web can, for example, be successively pulled off or rolled up after an application of labels to be able to always provide a free area for the application of labels, in particular defective labels.

In some embodiments, the sorting-out element can be supported at the application device and can be selectively movable into the working region of the application device. In such embodiments, the sorting-out element can in particular be movable along with the application device so that the application device does not first have to be moved to the sorting-out element to be able to transfer labels to the sorting-out element. Rather, the sorting-out element carried along can selectively be moved into the working region of the application device.

In some embodiments, the sorting-out element can be pushable, foldable and/or pivotable into the working region. For example, the sorting-out element can be pneumatically drivable to be able to be selectively guided into the working region of the application device.

In some embodiments, the sorting-out element can be of lamellar design, wherein the sorting-out element can in particular be movable, starting from an arrangement at an outer side of a housing of the application device, into the working region; and/or wherein the sorting-out element can in particular be movable, starting from a vertical orientation at an outer side of the application device, into a horizontal orientation on an arrangement in the working region.

To be able to move such a lamellar sorting-out element into the working region, rails for guiding the lamellas can, for example, be arranged at the application device and in particular at its housing. These rails can, for example, extend at an outer side and an underside (in particular in the case of a top labeler) or at an upper side of the application device (in particular in the case of a bottom labeler) so that the lamellar sorting-out element can be movable from a passive position at the outer side of the application device into an active position in the working region.

In some embodiments, the packaging machine can have a monitoring device for checking the labels transferred to the application device and a control device, wherein the control device can be configured to control the application device in dependence on a signal of the monitoring device to apply the labels to the material web or to transfer the labels to the sorting-out element.

The monitoring device can, for example, be configured to recognize defective labels, whereupon the control device can be configured to transfer such defective labels to the sorting-out element. For this purpose, the monitoring device can, for example, be configured to check the labels before the transfer to the application device and/or after the transfer to the application device, but before the application to the material web.

In particular, the control device can be configured to control the application device to apply the labels to provided packages or to first bring the application device into alignment with the sorting-out element, for example a sorting-out element fixedly held at the packaging machine, in order to transfer the labels to the sorting-out element. Furthermore, it can be provided that the control device is configured to selectively move a sorting-out element held at the application device into the working region of the application device in order, as a result, to achieve a transfer of a label, in particular a defective label, to the sorting-out element.

The control device can further in particular be a component of a control device of the packaging machine and/or a control device of an entire processing line that can in particular comprise a slicing apparatus for slicing food products into slices and the packaging machine. In this regard, the control device can in particular not be a separate control device of the labeling device, but the control device of the labeling device can be integrated into the control of the packaging machine and/or a processing line. However, it is generally also possible to provide such a control device as a separate control device of the labeling device. The control device can, for example, comprise a CPU and/or a microprocessor and suitable software to be able to generate and send commands to control a component of the packaging machine. Furthermore, the control device can have an operating device for receiving commands and/or for displaying information, for example a touchscreen.

In some embodiments, the monitoring device can have at least one camera and an image evaluation device, wherein the camera can be configured to record inspection images of labels before the application to the material web, wherein the image evaluation device can be configured to identify defective labels based on the inspection images. The control device can be configured to control the application device to apply the defective labels to the sorting-out element.

For example, provision can be made to provide the image evaluation device with reference images or comparison images of correct labels, for example in a readable, non-volatile memory, so that the image evaluation device can be configured to identify defective labels by comparing the inspection images with the reference images. For example, defective labels can have a crease due to which printed information becomes illegible. Furthermore, defective labels can, for example, have a poorly legible print, for instance, a smeared or incomplete print. Defective labels can thus be automatically recognized by such a monitoring device and can be transferred to the sorting-out element by controlling the application device accordingly in order to prevent the application of defective labels to the material web or provided packages.

In some embodiments, the control device can be configured to prevent and/or to delay the transfer of defective labels to the application device.

For example, the control device can be configured to transfer labels from a label stream provided by the label dispenser to the application device until a defective label would be transferred as the next label. The control device can then stop the transfer of labels to the application device in order to control the application device to apply the already transferred labels to assigned, provided packages. After the labels have been applied, the control device can be configured to transfer the defective label to the application device and to control the application device to transfer this defective label to the sorting-out element. Correct labels from the label stream provided by the label dispenser can then again be transferred to the application device until the next defective label is recognized.

In particular, the application device can be configured to simultaneously label a plurality of packages provided in parallel tracks or in a row. In such a case, the control device can be configured to control the label dispenser after a sorting out of a defective label to transfer only a number of correct labels to the application device that corresponds to a number of packages previously not labeled in the provided row. The application device can be configured to apply the taken-over labels to the packages of the row that have not yet been labeled, in particular in response to a corresponding command of the control device. Then, correct labels can again be transferred to the application device in a number corresponding to the number of tracks in order again to be able to simultaneously label a complete row of packages. A defective labeling of packages with the necessity of sorting out such packages can hereby be avoided—with only a small loss of time—wherein only the defective label has to be sorted out.

In other embodiments, however, provision can be made, on a recognition of a defective label, to transfer the defective label directly to the application device and to transfer all the labels located at the application device up to then to the sorting-out element. Furthermore, provision can be made to always transfer a number of labels corresponding to the number of packages in a row to the application device and to transfer an entire row of labels to the sorting-out element if one of the taken-over labels is defective. A defective labeling of packages can also be avoided in such embodiments.

In some embodiments, the camera can be attached to the application device and/or can be movable together with the application device. In this regard, the monitoring device can be part of the labeling device and/or the application device in some embodiments. The aforementioned image evaluation device can in particular be part of the control device and/or a software component of the control device.

The invention further relates to a labeling device for applying labels to a material web that is moved along a longitudinal direction by a packaging machine in order to produce packages for food products. The labeling device can in particular be configured according to any one of the embodiments explained above and can, for example, have a fixed-position motor for moving an application device, a label store that can be positioned in two equivalent positions, a vacuum device for generating a variable negative pressure in an inner space of the application device and/or a labeling device having a servomotor for driving application elements and/or belts of an application device.

The labeling device has a label dispenser for providing the labels and an application device for applying labels located in a working region of the application device to the material web, wherein the label dispenser is configured to transfer labels to be applied to the application device. The application device is further configured to apply labels received from the label dispenser selectively to the material web or to a sorting-out element.

In some embodiments, the sorting-out element can be supported at the application device and can be selectively movable into the working region of the application device. In this regard, the sorting-out element can be part of the labeling device and/or the application device.

In some embodiments, the sorting-out element can be pushable, foldable and/or pivotable into the working region, wherein a driving of the sorting-out element can, for example, take place pneumatically in such embodiments.

Furthermore, in some embodiments, the sorting-out element can be of lamellar design. In such embodiments, the sorting-out element can in particular be movable into the working region, starting from an arrangement at an outer side of a housing of the application device, and/or the sorting-out element can in particular be movable, starting from a vertical orientation, into a horizontal orientation on an arrangement in the working region. Furthermore, in such embodiments, the application device can have rails for guiding lamellas of the lamellar sorting-out element.

In some embodiments, the labeling device can have a monitoring device for checking the labels transferred and/or to be transferred to the application device. In particular, the monitoring device can be configured to check the labels before a transfer to the application device or after a transfer to the application device, but before an application of the labels to the material web. Furthermore, the monitoring device can be configured to detect defective labels.

The monitoring device can have at least one camera and an image evaluation device, wherein the camera can be configured to record inspection images of the labels before the application to the material web, wherein the image evaluation device can be configured to identify defective labels based on the inspection images. In particular, the camera can in this respect be arranged at the application device and/or can be movable together with the application device.

The image evaluation device can in particular be a component of a control device of the labeling device and/or of a packaging machine into which the labeling device is integrated. As already explained, the image evaluation device can in particular be configured to compare the inspection images with previously created reference images or comparison images of correct labels to be able to identify defective labels.

In some embodiments, the control device can be configured to generate a fault message when a sequence of defective labels is detected. In this regard, the control device can be configured to generate a signal that can be perceived by a person operating the labeling device when a sequence of defective labels is detected, for example, an acoustically or visually perceivable signal. A sequence of defective labels can in particular indicate that the labels provided on the label carrier tape are fundamentally defective so that the label carrier tape should be changed and, for example, a new roll of label carrier tape should be inserted into a label store of the label dispenser. Furthermore, a sequence of defective labels can, for example, indicate a fault at a printer printing the labels so that the settings of the printer should be checked or the printer accessories should be replaced. In some embodiments, the signal can also comprise information with respect to a component of the labeling device to be checked and/or an instruction for action that can, for example, be displayable on the control device.

Such a control device that is configured to generate a fault message when a sequence of defective labels is detected can in particular also be provided in embodiments of the packaging machine explained above.

The invention further relates to a method for operating a packaging machine, in particular a packaging machine comprising a labeling device whose application device is configured to selectively apply labels to a material web or a sorting-out element. In the method, a material web is moved along a longitudinal direction by the packaging machine and packages are produced from the material web. Furthermore, in the method, labels to be applied to the packages are transferred to an application device of a labeling device and the labels are applied to the packages by the application device. Furthermore, defective labels are transferred from the labeling device to a sorting-out element. In particular, defective labels are thus not applied to the packages.

As already explained above, defective labels can in particular be applied to the sorting-out element. Packages can hereby be prevented from being incorrectly labeled and therefore having to be completely sorted out.

In particular, provision can be made in the method that food products and/or food portions comprising one or more slices cut off from a food product are placed in the packages and packaged. For example, the packages can be produced in that depressions are formed in a bottom material web by the packaging machine and are then—after the insertion of a food portion or a food product—closed by a top material web fed from above. Furthermore, the packages can be labeled at an upper side and/or an underside. As an alternative to a packaging in depressions, provision can also be made to place the food products of the food portions on a flat bottom material web in order to then cover the deposited food products by a top material web fed from above and to produce closed packages. Furthermore, provision can be made to separate the packages after the labeling in order to obtain individual ready-for-sale packages.

In some embodiments, the labels to be applied can be checked by a monitoring device. In particular, defective labels can be automatically recognized by this check and the transfer of the defective labels to the sorting-out element can be automatically triggered.

In some embodiments, a plurality of packages disposed next to one another transversely, in particular perpendicular, to the longitudinal direction can be labeled simultaneously by applying a respective label by means of the application device of the labeling device, wherein, after the transfer of a defective label, the labels transferred to the application device can be applied to the sorting-out element and/or can be transferred to the sorting-out element.

For example, it can be provided to transfer all the labels transferred to the application device to the sorting-out element and in particular to apply them to the sorting-out element as soon as a defective label has been transferred to the application device. Furthermore, it can be provided to always—i.e. even after the transfer of a defective label—transfer a number of labels to the application device that corresponds to the number of packages disposed next to one another transversely to the longitudinal direction and, as a result of a transfer of a defective label, to transfer such a complete number of labels to the sorting-out element. Likewise, it can, however, be provided to stop the transfer of labels before the transfer of a defective label and to apply the labels transferred to the application device up to then to packages in order to then transfer the defective label to the application device and to transfer it to the sorting-out element, whereupon labels can be applied to packages that have not been labeled up to then in the provided row of packages disposed next to one another.

In some embodiments, a plurality of packages disposed next to one another transversely, in particular perpendicular, to the longitudinal direction are labeled simultaneously by applying a respective label by means of the application device of the labeling device. In such embodiments, on a recognition of a defective label in a label stream provided by a label dispenser, the following method can be performed:
the label to be transferred to the application device before the defective label can be transferred to the application device,
the transfer of the labels to the application device can be stopped,
the labels transferred to the application device can be applied to associated packages,
the defective label can be transferred to the application device and can be transferred to the sorting-out element, in particular applied to the sorting-out element,
a number of labels corresponding to the number of the plurality of packages to which no label has yet been applied and/or a number of labels up to a next defective label in the label stream can be transferred to the application device, and
the transferred labels can be applied to the not yet labeled packages of the plurality of packages.

In this regard, in such embodiments, the label stream can be briefly interrupted to be able to sort out only the defective label and to avoid an application of this defective label to a package in order to then label the packages remaining in a row of packages.

In such embodiments, the packaging machine can be configured to provide a plurality of packages disposed next to one another transversely, in particular perpendicular, to the longitudinal direction, simultaneously and in particular during a cycle pause. In particular, the packaging machine can be configured to provide a format of packages for a cycle pause.

In some embodiments, the application device can be moved to the sorting-out element in order to transfer the defective label to the sorting-out element or the sorting-out element can be moved into a working region of the application device in order to take over the defective label. For example, the sorting-out element can therefore be supported at the packaging machine or at the application device.

Furthermore, in some embodiments, a fault message can be generated when a plurality of consecutive defective labels are recognized.

The invention further relates to a labeling device for applying labels to a material web that is moved along a longitudinal direction by a packaging machine in order to produce packages for food products. The labeling device can in particular be configured according to any one of the embodiments explained above and can, for example, have a fixed-position motor for moving an application device, a label store that can be positioned in two equivalent positions, a vacuum device for generating a variable negative pressure in an inner space of an application device and/or a servomotor for driving application elements and/or belts of an application device. Furthermore, the labeling device can in particular have an application device that is configured to apply labels received from a label dispenser selectively to the material web or to a sorting-out element.

According to this aspect, the labeling device has a label dispenser for providing the labels and an application device for applying the labels to the material web, wherein the label dispenser is configured to transfer labels to be applied to the application device. Furthermore, the labeling device, however, has a discarding device that is configured to selectively prevent the transfer of a label to be discarded to the application device.

In this regard, with the labeling device according to this aspect of the invention, provision can in particular—as an alternative or in addition to the possibility of transferring a defective label to a sorting-out element—be made not to transfer labels to be discarded to the application device in the first place, but to already discard them beforehand by means of the discarding device. In particular, labels to be discarded can for this purpose be left on a label carrier tape on which the labels are provided and cannot be released from the label carrier tape, as will be explained in more detail below.

Labels to be discarded can in particular be defective labels that can, for example, have a defective or poorly legible print or a crease. Since in particular such defective labels can be discarded, packages can efficiently be prevented from being incorrectly labeled and complete packages can therefore be prevented from having to be sorted out. Rather, by using the discarding device, it can be achieved that only correct labels are transferred to the application device as labels to be applied to the material web so that the material waste during the operation of the labeling device can also be reduced, in particular to the label carrier tape and any defective labels remaining thereat, without having to sort out entire packages, in particular filled packages, or having to provide a sorting-out surface that may likewise have to be subsequently disposed of under certain circumstances.

As already explained, the labeling device and/or a packaging machine that comprises the labeling device can in particular have a monitoring device to be able to identify defective labels and/or labels to be discarded. For example, due to such a monitoring device, a label stream of labels provided at a label carrier tape can be monitored in order, when a defective label is detected, to determine the respective label as a label to be discarded and to prevent a transfer of the label to the application device. Such a detection can in particular take place, as already explained above, by means of a camera that images the labels of the label stream and that makes the generated images available to an image evaluation device as inspection images. The image evaluation device can then in particular compare the inspection images with reference images or comparison images of correct labels and/or of labels to be applied to be able to detect labels that are defective and therefore have to be discarded.

In some embodiments, the discarding device can be movable between a passive position and a discarding position, wherein the labels to be applied can be transferrable to the application device in the passive position of the discarding device and wherein the transfer of the label to be discarded can be preventable by moving the discarding device into the discarding position.

In particular, when the discarding device is positioned in the passive position, the labels can therefore so-to-say be transferrable unimpeded and/or without interaction with the discarding device to the application device, wherein this transfer can, when the discarding device is positioned in the passive position, in particular take place as in the case of conventional labeling devices in that a label carrier tape is guided over a transfer edge and the labels are thereby released from the label carrier tape. By moving the discarding device into the discarding position, on the other hand, a transfer of the label to be discarded, or possibly, however, also of a sequence of labels to be discarded, to the application device can be prevented so that an application of the label to be discarded and, for example, of a defective label to the material web can also be prevented. In particular, this can be achieved by preventing a release of the label to be discarded from the label carrier tape.

In particular, to prevent the transfer of a label to be discarded to the application device, the discarding device can act on, deflect and guide a front edge of the label to be discarded in order to fix the front edge of the label as closely as possible to a carrier material, on which the label is provided, in the region of the transfer edge or of a deflection at the transfer edge.

In some embodiments, the discarding device can be pivotable, foldable and/or displaceable in a translatory manner from the passive position into the discarding position. In this regard, in some embodiments, in particular a positioning of the discarding device in space can be variable to be able to move the discarding device between the passive position and the discarding position.

Alternatively or additionally, in some embodiments, a shape of the discarding device can further be changeable in order to move the discarding device from the passive position into the discarding position. For example, a discarding device, which is spaced apart in the passive position from the label to be discarded and/or from a label carrier tape to which the label to be discarded is applied, can be able to be brought into contact with the label to be discarded and/or with the label carrier tape by changing a shape of the discarding device. This can be achieved, for example, by configuring the discarding device as an inflatable discarding device in order, by inflating the discarding device or a discarding element of the discarding device, to be able to bridge a spacing between the discarding device and the label to be discarded and/or the label carrier tape and to be able to bring the discarding device into contact with the label to be discarded and/or the label carrier tape. In this regard, in the passive position, a deformable discarding device can in particular have a greater spacing from the label to be discarded than in the discarding position without, however, a position of a center of gravity of the discarding device necessarily having to change when the discarding device is moved between the passive position and the discarding position.

In addition, in some embodiments, the discarding device can be movable from the passive position into the discarding position by a combination of the movements explained above (pivoting, folding, displacement) in that the discarding device can, for example, first be displaced in a translatory manner, starting from the passive position, in order to then be pivoted or folded into the final discarding position.

In general, in some embodiments, the discarding device can, by moving into the discarding position, be brought into active contact, in particular into direct mechanical contact, with the label to be discarded and/or with a label carrier tape in order to prevent the transfer of the label to be discarded to the application device.

To be able to move the discarding device between the passive position and the discarding position, the labeling device can, for example, comprise a drive, wherein such a drive can, for example, comprise an electric motor and/or a servomotor or a pneumatic drive. Furthermore, it can, for example, be provided that the discarding device is preloaded towards the discarding position, for example by a spring, in order, by releasing it for a movement into the discarding position, to be able to move directly into the discarding position. In such embodiments, the labeling device can in particular have a drive, for example having an electric motor and/or a servomotor or a pneumatic drive, to be able to urge the discarding device against the preload into the passive position and to enable the transfer of the labels to be applied to the application device.

To change the shape of the discarding device, the labeling device can, for example, have a compressed air device to be able to inflate the discarding device and/or a discarding element and in particular to be able to bring said discarding device and/or discarding element into contact with the label to be discarded. In general, a change in a shape of the discarding device for transferring the discarding device into the discarding position can, however, in particular comprise an expansion of the discarding device, wherein such an expansion can, for example, take place by the aforementioned compressed air device, but also by suitable drives that are configured to drive sections of the discarding device and, as a result, to move them relative to one another. Furthermore, in some embodiments, the discarding device can enclose a larger volume in the discarding position than in the passive position.

In some embodiments, the label dispenser can have a label store in which a label carrier tape rolled up into a roll can be inserted, on which label carrier tape the labels to be transferred to the application device (and also the label that is ultimately to be discarded) are provided. The label dispenser can be configured to guide the label carrier tape over a transfer edge in order to transfer the labels to the application device and, as a result, to release said labels from the label carrier tape. In such embodiments, the discarding device can be configured to prevent a release of the label to be discarded from the label carrier tape in the discarding position.

In particular, in such embodiments, the discarding device can be configured to interact with the transfer edge in order to prevent a transfer of the label to be discarded to the application device. Therefore, the label to be discarded can, when the discarding device is positioned in the discarding position, be guidable on the label carrier tape, for example along the transfer edge and in particular around the transfer edge, without being released from the label carrier tape. In such embodiments, the label to be discarded can thus in particular also after passing the transfer edge still be arranged at the label carrier tape, provided that the discarding device was positioned in the discarding position during the passing of the transfer edge.

As already mentioned, the release of the label to be discarded from the label carrier tape can in particular be avoidable in that the discarding device can be configured, in the discarding position, to fix a front edge of a label to be discarded to the label carrier tape.

In general, in particular front edges of the labels to be applied can, as free label ends, first be released tangentially to a label carrier tape guided around the transfer edge from the label carrier tape, whereupon parts of the label adjacent to the front edge can adjoin the already released front edge when moving over the transfer edge and can be released from the label carrier tape. If, on the other hand, the front edge is fixed in the region of the transfer edge so that the front edge of the label is still located at the label carrier tape even after passing the transfer edge, a part of the label that adjoins the front edge cannot be released from the label carrier tape by guiding it around the transfer edge since no free label end pointing in the direction of the transfer edge is moved over the transfer edge anymore. Rather, in this case, during the further movement around the transfer edge, the label is, always at a section that has already been guided around the transfer edge, still held at the label carrier tape. Therefore, it can be sufficient to fix the label to be discarded to the front edge, wherein, during operation, the discarding device can in particular already be transferred into the passive position again as soon as the front edge of the label (and possibly a defined further part of the label to be discarded, but not necessarily the entire label) has passed the transfer edge.

In some embodiments, the passive position can correspond to an upper position and the discarding device can be movable from above the transfer edge into the discarding position. Alternatively thereto, in some embodiments, the passive position can correspond to a lower position and the discarding device can be movable from below the transfer edge into the discarding position.

Furthermore—both starting from a passive position as the upper position and starting from a passive position as the lower position—the discarding device can, in the passive position, in some embodiments, be positioned laterally spaced apart from the transfer edge and can be movable into the discarding position by a lateral movement towards the transfer edge, in particular in combination with a downwardly or upwardly directed movement. Furthermore, the passive position can also correspond exclusively to a lateral position of the discarding device and, in some embodiments, the discarding device can be transferrable into the discarding position by a lateral, in particular horizontal, movement towards the transfer edge.

In some embodiments, the discarding device can have a deflection contour that is configured to hold the label to be discarded on the label carrier tape at the transfer edge. In particular, the deflection contour can be configured to hold the label on the label carrier tape at the transfer edge such that the label can be guided around the transfer edge on the label carrier tape. Furthermore, the deflection contour can in particular be configured to hold the label to be discarded on the label carrier tape at the transfer edge when the discarding device is in the discarding position. On the other hand, in the passive position of the discarding device, the deflection contour can in particular be arranged spaced apart from the label to be discarded and/or the transfer edge in order to enable a transfer of the labels to be applied to the application device.

Such a deflection contour can in particular also be designated as a guide gate by which the label to be discarded can so-to-say be guided around the transfer edge so that the label to be discarded is still located on the label carrier tape even after passing the transfer edge and a release of the label to be discarded from the label carrier tape can be prevented. For example, the deflection contour can for this purpose have a contour corresponding to a path of the label carrier tape around the transfer edge so that the label to be discarded can be limited at both sides at the transfer edge by the label carrier tape, on the one hand, and the deflection contour, on the other hand, and can be blocked by the deflection contour against a release from the label carrier tape—in particular against a movement perpendicular or tangential to the path of the label carrier tape.

In particular, in some embodiments, the deflection contour can be active in the region of the transfer edge, whereas the label to be discarded can be further guidable exclusively by the label carrier tape after passing the transfer edge. A path of the label carrier tape can in particular only form a sufficiently sharp bend at the transfer edge so that the labels can be released from the label carrier tape. Apart from the transfer edge, the label carrier tape can, however, always be guided with a path curvature that is sufficient to ensure that labels adhesively bonded to the label carrier tape are not released from the label carrier tape due to the curvature of the path of the label carrier tape so that a support of the labels to be discarded, in particular at a label front edge, in the region of the transfer edge can be sufficient.

In some embodiments, by moving the discarding device into the discarding position, the deflection contour can be able to be brought into contact with the label carrier tape that is moved around the transfer edge and/or with the label to be discarded that is moved around the transfer edge. As already explained, due to such a contact and in particular a directly mechanical contact, a release of the label to be discarded from the label carrier tape can be prevented since a movement of the label to be discarded away from the label carrier tape can be blocked by the deflection contour contacting the label.

In some embodiments, the discarding device can be configured to develop a pressure on the label to be discarded at the transfer edge in order to prevent a release of the label to be discarded from the label carrier tape. In particular, it can be possible to develop such pressure by bringing the discarding device into contact with the label to be discarded, which label is moved around the transfer edge, when the discarding device is moved into the discarding position.

In some embodiments, the discarding device can comprise a pressure element, and in particular a pressure roller, for developing the pressure, wherein the pressure element can in particular be pneumatically deflectable and/or can be preloaded towards the transfer edge. Furthermore, the pressure element can, for example, be elastically deformable to be able to exert a pressure on the label to be discarded but to still be able to permit certain tolerances.

For example, the discarding device can have a pressure element that can be extendable directly in the direction of the transfer edge in order to press the element to be discarded against the label carrier tape at the transfer edge and thus to prevent a release of the label to be discarded from the label carrier tape. However, such a pressure element can, for example, also be provided in combination with the aforementioned deflection contour, wherein the pressure element can, for example, be configured to exert a pressure on the label to be discarded directly at the transfer edge. Alternatively thereto, the pressure element can, for example, be provided to develop a pressure on the label to be discarded downstream of the transfer edge in order to stabilize the label to be discarded during the movement around the transfer edge. In particular, the pressure element can for this purpose be arranged such that the pressure element can exert a pressure on a downstream section of a label to be discarded while an upstream section of the label to be discarded has not yet passed the transfer edge.

In particular, in some embodiments, the aforementioned deflection contour can therefore comprise an additional pressure element that can, for example, be spring-loaded and/or can be movable by a drive to be able to exert a pressure on the label to be discarded.

A configuration of the pressure element as a pressure roller can further in particular allow a movement of the label carrier tape along the provided path in an unimpeded manner, but can prevent a movement of the label to be discarded perpendicular or tangentially to this path for a release from the label carrier tape. In particular, the pressure roller can therefore be rotatable relative to the label carrier tape when the pressure roller is in contact with the label carrier tape.

Alternatively or additionally, in some embodiments, the discarding device can have a compressed air device for developing the pressure, which compressed air device is configured to generate a compressed air flow directed towards the label to be discarded. In particular, the compressed air flow can be controllable to be able to generate a compressed air flow only when a label to be discarded is guided around the transfer edge, but otherwise to enable a transfer of labels to the application device and not to generate a compressed air flow that impairs the release of the labels from the label carrier tape.

In some embodiments, the discarding device can be configured to change a path of the label carrier tape around the transfer edge, in particular to reduce a curvature of the path at the transfer edge, in order to prevent the transfer of the label to be discarded.

With the discarding device positioned in the passive position, the label carrier tape can in particular be guidable around a pointed edge at the transfer edge so that the path of the label carrier tape can generally have a sharp bend or a pronounced path curvature at the transfer edge. In particular due to such path guidance around a bend, labels provided on the label carrier tape can be released from the label carrier tape in order to then be received by the application device.

Since, in some embodiments, the discarding device can, however, be configured to change the path of the label carrier tape in the region of the transfer edge, a guidance of the label carrier tape around such a sharp bend can be prevented and in particular a curvature of the path of the label carrier tape in the region of the transfer edge can be prevented in order, as a result, to override a necessary condition for releasing a label—the pronounced curvature of the path at the transfer edge—to a certain extent.

For example, it can be provided that the discarding device comprises a downstream deflection for the label carrier tape, viewed from the transfer edge, and is configured to displace the downstream deflection such that a curvature of the path of the label carrier tape is reduced at the transfer edge. In particular, the discarding device can be configured to displace such a downstream deflection along a direction along which the label carrier tape can be moved before reaching the transfer edge in order, as a result, to attenuate or make more continuous a change in direction which the label carrier tape experiences at the transfer edge.

Furthermore, it can, for example, be provided that the discarding device is configured to enlarge a deflection over which the label carrier tape can be guided at the transfer edge in order, as a result, to enlarge a radius of the path of the label carrier tape at the transfer edge or to reduce the curvature of the path at the transfer edge.

In some embodiments, the discarding device can have an inflatable discarding element, wherein the path of the label carrier tape can be changeable by inflating the inflatable discarding element and the label carrier tape can be movable along the inflated discarding element. In particular, in such embodiments, the discarding device can be movable from the passive position into the discarding position by inflating the discarding element.

The inflatable discarding element can in particular be able to be brought into contact with the label carrier tape by the inflation to be able to sectionally guide the label carrier tape in the inflated state and, as a result, to be able influence the path of the label carrier tape. Furthermore, it can be provided that the label carrier tape is already guided via the discarding element even when the discarding element is not inflated, wherein the path of the label carrier tape can, however, be changeable by an expansion of the discarding element as a result of an inflation.

In some embodiments, the inflatable discarding element can be arranged downstream of the transfer edge with respect to the path of the label carrier tape. Alternatively thereto, the inflatable discarding element can be integrated into the transfer edge in some embodiments.

For example, the inflatable discarding element can act as a deflection of the label carrier tape at the transfer edge so that one dimension of the discarding element can directly determine a path of the label carrier tape at the deflection edge. By inflating such a discarding element, a radius of the deflection around which the label carrier tape is guided at the transfer edge can, for example, be increased in order, as a result, to be able to reduce a curvature of the path of the label carrier tape at the transfer edge and to be able to prevent a release of the label to be discarded from the label carrier tape. Furthermore, due to a discarding element arranged downstream of the transfer edge, a relative orientation between a deflection of the label carrier tape, said deflection being downstream relative to the transfer edge, and the transfer edge can be changeable to be able to reduce a curvature of the path of the label carrier tape along the transfer edge and to be able to prevent a release of the label to be discarded. For this purpose, the downstream deflection can, for example, be displaceable and/or expandable by inflating the discarding element, wherein the discarding element can in particular also form the downstream deflection.

In some embodiments, the discarding device can have, for changing the path, a deflection element that can selectively be brought into contact with the label carrier tape, in particular a deflection roller. For example, such a deflection element can be displaceable by a drive to be able to be brought into contact with the label carrier tape.

In some embodiments, the label dispenser can have at least one compensating element, in particular a rocker, a pressure roller and/or a dancer roller, that is configured to adapt a path of the label carrier tape downstream of the transfer edge to the change of the path of the label carrier tape around the transfer edge. In particular, such a compensating element can form a deflection for the label carrier tape downstream of the transfer edge and can be passively supported to be able to be able to allow a change in the path of the label carrier tape by a movement of the discarding device from the passive position into the discarding position and to be able to compensate for any tension in the label carrier tape produced by the path change. On a subsequent movement of the discarding device into the passive position, the compensating element can, however, likewise return to the initial position to be able to restore the original path guidance. For this purpose, the compensating element can in particular be preloaded into this initial position.

In some embodiments, the discarding device can be arranged at the application device. Alternatively thereto, in some embodiments, the label dispenser can comprise the discarding device. A discarding device arranged at the application device can in particular be movable together with the application device.

In some embodiments, the labeling device can have a monitoring device for monitoring the labels transferred to the application device and a control device, wherein the monitoring device can be configured to identify the label to be discarded. In such embodiments, the control device can furthermore be configured to control the discarding device in dependence on a signal of the monitoring device to prevent the transfer of the label to be discarded. In particular, the monitoring device can be configured to identify defective labels as labels to be discarded and to emit a corresponding signal, wherein the control device can, in response to such a signal, control the discarding device to prevent the transfer of the label to be discarded, in particular by moving the discarding device into the discarding position.

The monitoring device can in particular be configured as already explained above in connection with a labeling device comprising a sorting-out element and can, for example, have at least one camera and an image evaluation device, wherein the camera can be configured to record inspection images of the labels before the application to the material web. The image evaluation device can in turn be configured to identify defective labels based on the inspection images and the discarding device can be configured to discard the defective labels as labels to be discarded.

Furthermore, the camera can in particular be arranged at the application device and/or can be movable together with the application device.

In some embodiments, the control device can furthermore be configured to generate a fault message when a sequence of defective labels and/or labels to be discarded is detected.

Furthermore, the invention relates to a packaging machine for packaging food products, in particular food portions that comprise one or more slices cut off from a food product, wherein the packaging machine comprises a transport device that is configured to move a material web along a longitudinal direction in order to produce packages. Furthermore, the packaging machine comprises a labeling device of the kind described above comprising a discarding device for discarding labels to be discarded.

The invention also relates to a method for operating a packaging machine, in particular the above-mentioned packaging machine, comprising a labeling device that has a discarding device, wherein in the method:
a material web is moved along a longitudinal direction by the packaging machine,
packages are produced from the material web,
labels to be applied to the packages are transferred to an application device of a labeling device, and
the labels are applied to the packages by the application device,
wherein a transfer of defective labels to the application device is, however, prevented by a discarding device of the labeling device.

In this regard, in the method, defective labels can be prevented from being transferred to the application device so that the defective labels are not applied to the material web either, but can, for example, be disposed of together with a used label carrier tape on which the defective labels can still be located.

In some embodiments of this method, it can be provided that the labels to be applied are checked by a monitoring device. In particular, the monitoring device can be configured to recognize the defective labels and a control device of the packaging machine can be configured to control the discarding device in dependence on a signal of the monitoring device to discard the defective labels or to prevent the transfer of the defective labels to the application device.

In some embodiments, a return of the discarding device from the discarding position into the passive position so that the next label can be transferred to the application device for application can in particular take place immediately after a label to be discarded has passed the transfer edge. To achieve high speeds during operation, the return can even already take place during the deflection of a label to be discarded at the transfer edge, i.e. while a part of the label to be discarded is still located at the transfer edge. The return can preferably take place as soon as at least half and/or most of the label to be discarded has passed the transfer edge since a release of the rear label end from the carrier web is then no longer possible or is at least no longer detrimental for the discarding of this label.

In general, in some embodiments, the discarding device can therefore be movable into the passive position again after the discarding of the label to be discarded. In particular, the discarding device can, however, already be movable into the passive position while a part of the label to be discarded is still in the region of a transfer edge, provided that a front edge of the label to be discarded has already passed the transfer edge.

In principle, in all of the embodiments of a labeling device disclosed here, it can be provided that the respective labeling device has a printer for printing the labels. Furthermore, the labels can in particular be adhesively bondable to the material web. Furthermore, each of the disclosed labeling devices can generally be a top labeler or a bottom labeler, i.e. a labeling device that is configured to label packages at an upper side or to label packages at an underside.

The packaging machines disclosed here can in particular be configured as deep-draw packaging machines. Furthermore, the packaging machine can in particular be configured to move a bottom material web and a top material web along the longitudinal direction, wherein the labeling devices can be configured to apply labels to the top material web and/or the bottom material web. The material web moved by the packaging machine can in particular be a film, a paper web or a material web composed of organic materials.

The invention is explained in the following, purely by way of example, based on embodiment examples with reference to the drawings.

### BRIEF DESCRIPTION OF THE DRAWINGS

There are shown:

FIG. 1 a schematic representation of a packaging machine for packaging food products;

FIGS. 2A and 2B a respective schematic representation of a labeling device of the packaging machine, wherein the labeling device shown in FIG. 2A is configured for applying labels to an upper side of a material web moved on a packaging machine and wherein the labeling device shown in FIG. 2B is configured for applying labels to an underside of a material web moved on the packaging machine;

FIG. 3 a schematic plan view of the packaging machine and the labeling device;

FIGS. 4A to 4C a perspective view and two frontal views of a section of the packaging machine in which two labeling devices for applying labels to a material web moved by the packaging machine are arranged;

FIGS. 5A and 5B a respective perspective side view of the packaging machine to illustrate a drive for moving a respective application device of the labeling devices along a longitudinal direction of the packaging machine;

FIGS. 6A and 6B a respective perspective view of the application device, which can be moved along the longitudinal direction, of the labeling device for applying labels to the upper side of the material web or of the labeling device for applying labels to the underside of the material web;

FIG. 7 a perspective frontal view of the application device with the housing shown transparent;

FIGS. 8A and 8B a respective schematic representation of an application device of a labeling device comprising a vacuum device configured to generate a variable negative pressure in an inner space of the application device;

FIGS. 9A and 9B a perspective side view and a perspective rear view of the application device with the housing shown transparent to illustrate a drive of application elements for applying labels to the material web;

FIG. 10 a perspective front view of the application device with the housing shown transparent to illustrate a drive for driving a plurality of belts by means of which labels can be moved transversely to the longitudinal direction;

FIG. 11 a schematic plan view of a packaging machine comprising a labeling device whose application device is configured to selectively transfer labels to a sorting-out element;

FIGS. 12A and 12B a respective schematic view of an application device of a labeling device with an integrated sorting-out element;

FIGS. 13A to 13C schematic representations of the application device to illustrate a method in which a defective label is transferred to a sorting-out element of the application device and correct labels are applied to packages provided by the packaging machine;

FIGS. 14A and 14B a respective schematic representation of a labeling device comprising a discarding device that is configured to selectively prevent a transfer of labels to be discarded to an application device of the labeling device, wherein the discarding device is shown in a passive position or in a discarding position;

FIGS. 15A and 15B a respective schematic representation of a further embodiment of a labeling device comprising a discarding device when the discarding device is positioned in the passive position or when the discarding device is positioned in the discarding position;

FIGS. 16A and 16B a respective schematic representation of a further embodiment of a labeling device comprising a discarding device that has an inflatable discarding element by means of which a path of a label carrier tape can be changed;

FIGS. 17A and 17B a respective schematic representation of a further embodiment of a labeling device comprising a discarding device that has a movable deflection element by means of which a path of a label carrier tape can be changed; and

FIGS. 18A and 18B a respective schematic representation of a further embodiment of a labeling device comprising a discarding device with the discarding device positioned in the passive position or with the discarding device positioned in the discarding position, wherein the discarding device has a compressed air device for generating a compressed air flow.

### DETAILED DESCRIPTION

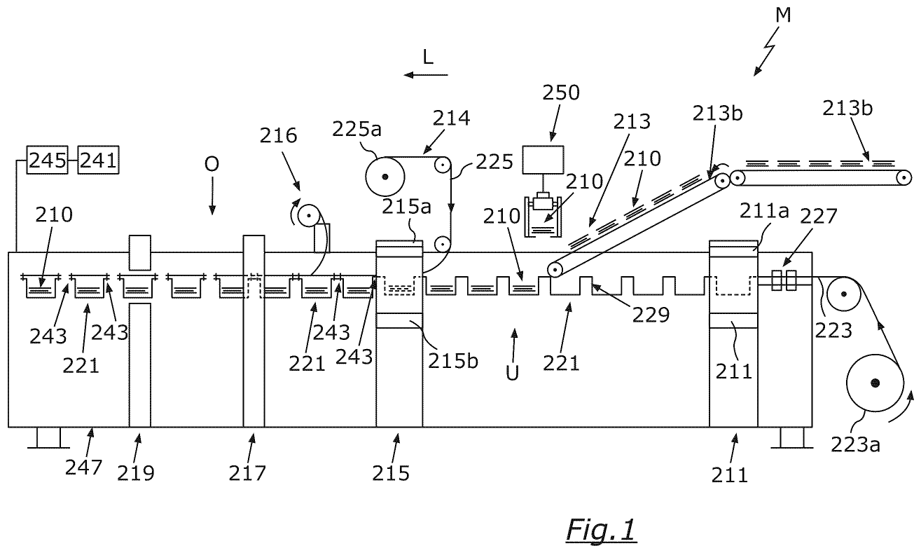

FIG. 1 schematically shows a packaging machine M working in a longitudinal direction L and comprising a machine frame 247. A transport chain 227, which is only schematically shown here at the upstream end of the machine, is guided at a left-hand side frame and at a right-hand side frame of the machine frame 247 in each case. The two transport chains 227 together form a transport device 227 for a bottom material web 223 drawn from a supply roll 223a so that the transport device 227 is configured to move the bottom material web 223 along the longitudinal direction L.

The packaging machine M comprises a plurality of work stations following one another in the longitudinal direction L, namely a molding station 211 also designated as a deep-drawing machine or a thermal molding machine, an insertion station 213 for food products 210 to be packaged, a feed station 214 for a top material web 225 drawn from a supply roll 25a, a labeling station 216, a transverse separating station 217 and a longitudinal separating station 219.

The food products 210 to be packaged are in particular food portions in the illustrated embodiment that each comprise a plurality of slices that were previously cut off from a loaf-shaped or bar-shaped food, such as sausage, cheese, ham or meat, by means of a slicing apparatus (not shown). The slicer and the packaging machine M can form a continuous processing line.

A central control device 241 controls the operation of the packaging machine M, including the work stations mentioned. It can also control the slicer or be connected to a control device of the slicer. Furthermore, the packaging machine M is provided with an operating device 245 which e.g. comprises a touch screen at which all the necessary information can be displayed to an operator and the operator can make all the necessary settings before and during the operation of the packaging machine M.

The design and operation of said work stations are generally known to the skilled person so that they will not be discussed in detail here.

However, it should be pointed out that, for example, the molding station 211 has a top tool 211a and a bottom tool 211b, by means of which recesses 229, also referred to as depressions, are formed in the bottom material web 223 in a deep-drawing process in each case. The portions 210 mentioned are inserted into these recesses 229 at the insertion station 213. The insertion station 213 here comprises a so-called feeder of which two endless conveyor belts 213a, 213b are shown. Alternatively or additionally, the insertion station 213 can comprise a robot 250, e.g. in the form of a so-called “picker”, that is likewise schematically shown here and that can be configured as a delta robot having a gripper 52 that comprises two claws jointly holding a respective portion 210. Such robots and their use in the handling of foods, in particular when inserting portions into recesses 229 of packages, are generally known to the skilled person so that further statements are not necessary here.

The bottom material web 223 provided with the filled recesses 229 and the top material web 225 are subsequently fed to the sealing station 215 that comprises a top tool 215a and a bottom tool 215b. The material webs 223 and 225 are connected to one another by means of these tools 215a, 215b. The recesses 229 and thus the packages 221 formed by the material webs are hereby closed. Sealing points 243, also called sealing seams, extending transversely to the longitudinal direction L are schematically indicated in FIG. 1.

Subsequent to the sealing station 215, the packages 221 are still connected and therefore still have to be separated. In the embodiment shown here, the packages 221 are provided with labels at the labeling station 216 before the separation.

Further conveyor belts and/or work stations, for example a scale for checking the weight of the packages 21, can be provided downstream of the separating stations 217, 219.

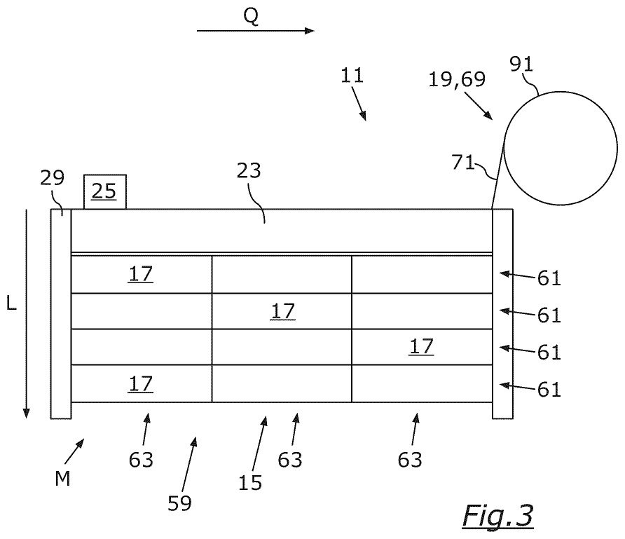

Applications can e.g. differ from one another with respect to the kind of products 210 to be packaged, the size/shape of the recesses 229 in the longitudinal and/or transverse direction or with respect to a format set. Thus, e.g. per work cycle of the packaging machine, a format or format set of 3×4 (3 in the transverse direction and 4 in the longitudinal direction) recesses 229 or product receivers of other kinds can be formed in the molding station 211, a format set of 3×4 correspondingly arranged products 210 can be inserted into a respective format set of recesses 221 at the insertion station 213, and a respective format set of 3×4 recesses 229 filled with products 210 can be sealed at the sealing station 215. The same applies to the labeling station 216 (cf. also FIG. 3).

An arbitrarily dimensioned n×n format set can generally be formed, in particular where n>=2 and m>=1.

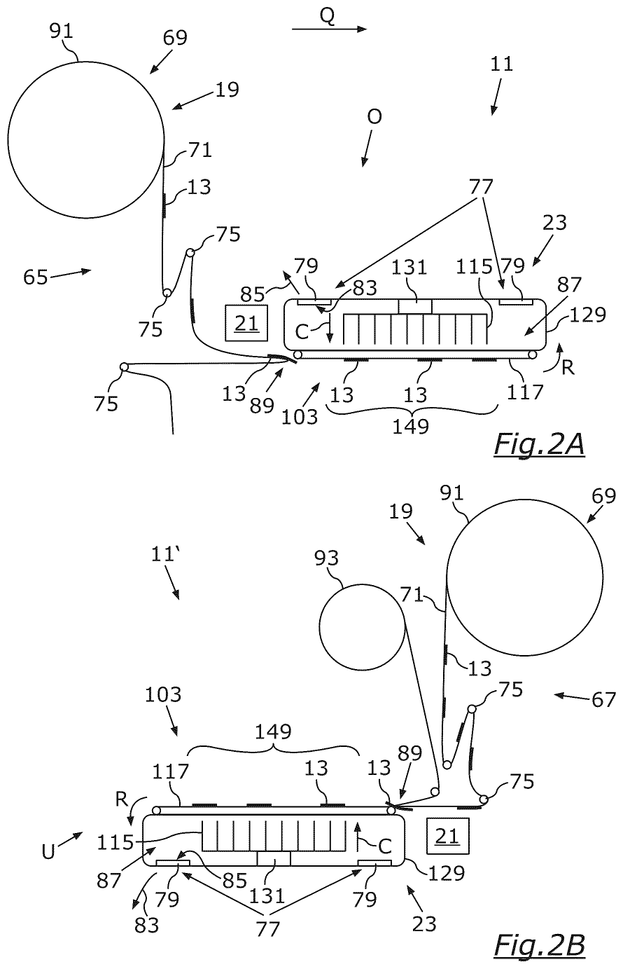

FIG. 2A illustrates the basic principle of a first labeling device 11 of the labeling station 216 of the packaging machine M that is configured to apply labels 13 to an upper side O of the packages 221 provided by the packaging machine M or to the upper side O of the top material web 225.

The labeling device 11 comprises a label dispenser 19 that is configured to provide labels 13 and to transfer them to an application device 23 that is in turn configured to apply taken-over labels 13 to the packages 221 or the top material web 225. For this purpose, the label dispenser 19 has a label store 69 into which a roll 91 of a wound-up label carrier tape 71 is inserted, wherein a plurality of labels 13 are applied, and in particular adhesively bonded, to the label carrier tape 71. The label carrier tape 71 is drawn from the roll 91 and is guided via a plurality of deflection and/or dancer rollers 75 to a printer 21 of the labeling device 11, by which printer 21 the labels 13 can be printed in order, for example, to be able to apply information to the labels 13 that relates to a food product 210 packaged in the package 221 to be labeled.

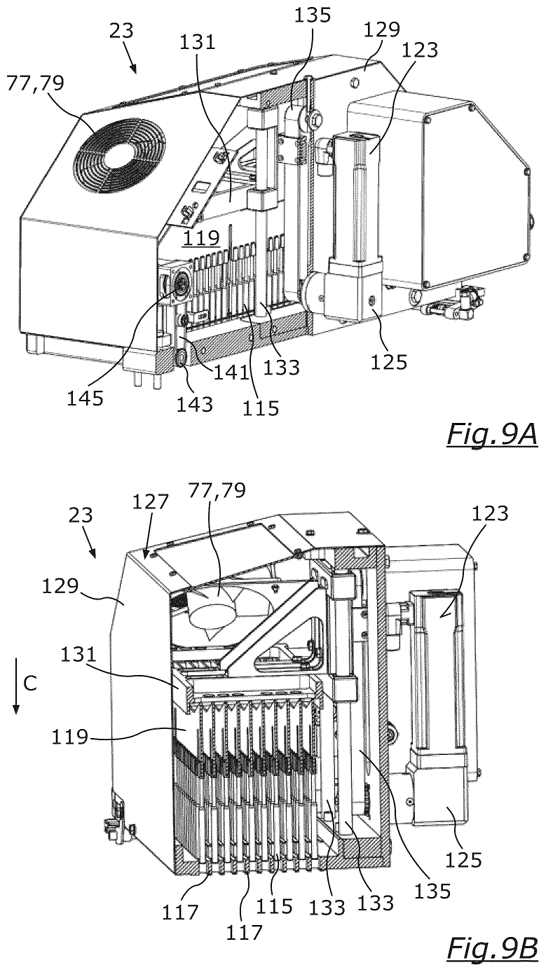

After the labels 13 have been printed by the printer 21, the label carrier tape 71 is guided over a transfer edge 89 so that the label carrier tape 71 can be bent and the labels 13 can be released from the label carrier tape 71. By releasing the labels 13 from the label carrier tape 71, the labels 13 are transferred to the application device 23 that has a plurality of belts 117 revolving along a direction R to be able to move the received labels 13 along a transverse direction Q oriented transversely to the longitudinal direction L and to be able to position them above respective packages 17 to be labeled (cf. also FIGS. 9A to 10 and FIGS. 13A to 13C).

To be able to take over the labels 13 from the label dispenser 19 and to hold them against gravity, the application device 23 has a vacuum device 77 that is configured to generate a negative pressure in an inner space 87 of the application device 23 and in particular in a housing 129 of the application device 23, whereby the taken-over labels 13 can be sucked onto a working side 103 of the application device 23. To generate the negative pressure in the inner space 87, the vacuum device 77 comprises two fans 79 whose respective suction side 83 is disposed in the inner space 87 of the application device 73, whereas the respective pressure side 85 of the fans 79 is disposed outside the housing 129 and the inner space 87.

Due to the revolving of the belts 117 along the direction R, the taken-over labels 13 can in particular be moved into a working region 149 of the application device 23, wherein a plurality of application elements 115 that are movable in the vertical direction C are arranged in the working region 149 and can engage between belts 117 that are disposed next to one another and that are spaced apart from one another to be able to release the labels 13 from the belts 117 and to be able to apply them to an upper side O of a provided package 221 or 17 (cf. also FIGS. 9A to 10 and FIGS. 13A to 13C). To be able to move the application elements 115, which can in particular be configured as pins, the application elements 115 are jointly held at a carriage 131 that is movable in the vertical direction C. By lowering the carriage 131, all the labels 13 located in the working region 149 of the application device 23 can therefore be applied to a material web 15 or 225 provided by the packaging machine M.

FIG. 2B shows a schematic representation of a second labeling device 11′ of the packaging machine M or its labeling station 216 that is configured to apply labels 13 to an underside U of a provided material web 15, in particular the bottom material web 223, and/or the underside U of the packages 221 or 17. The second labeling device 11′ is in this respect generally configured according to the same principle as the labeling device 11 illustrated by means of FIG. 2A, wherein the application of the labels 13 to the underside U, however, requires a mirrored arrangement, so to speak. Therefore, the label store 69 of the labeling device 11 is arranged at a first side 65 of the packaging machine M, whereas the label store 69 of the second labeling device 11′ is arranged at a second side 67 of the packaging machine M that is opposite the first side 65. Furthermore, it is schematically illustrated in FIG. 2B that the label carrier tape 71 can be wound up into a discharge roll 93 after the transfer of the labels 13 at the transfer edge 89.

With the labeling device 11′, the labels 13 are thus also guided over a transfer edge 89 and transferred to an application device 23, in whose inner space 87 a negative pressure is generated by two fans 79 of a vacuum device 77 to stabilize the labels 13 that are moved in the transverse direction Q into a working region 149 of the application device 23 by means of a plurality of mutually offset belts 117. In particular, the two labeling devices 11 and 11′ can be arranged at the labeling station 216 of the packaging machine M to be able to provide the provided packages 221 with a respective label 13 both at the upper side O and at the underside U. In the labeling device 11′ provided for applying labels 13 to the underside U, the application elements 115 can in particular be released from the application device 23 by an upward movement of the carriage 131 in the vertical direction C and can be applied to the underside U at the provided packages 221 or at the bottom material web 223.

FIG. 3 further illustrates, in a schematic plan view of the packaging machine M, that the packaging machine M, as already mentioned in connection with FIG. 1, can be configured to operate in cycles and to provide a format 59 of packages 17 in a respective cycle, wherein the format here by way of example comprises packages 17 that are arranged in three tracks 63 aligned in parallel with the longitudinal direction L and in four rows 61 oriented in the transverse direction Q. It is therefore shown by way of example that the packaging machine M provides twelve packages 17 in each cycle that are arranged in a 3 (tracks 63)×4 (rows 61) matrix that determines the format 59.

Furthermore, the labeling device 11 and 11′ can be configured, during a cycle pause, i.e. when the material web 15 is stationary, to completely label the packages 17 provided in the format 59 by applying respective labels 13 to the packages 17. For this purpose, it can first be provided that the label dispenser 19 is configured to transfer a number of labels 13 corresponding to the number of tracks 63 to the application device 23, which labels can then be moved in the transverse direction Q into respective positions assigned to the packages 17 by driving the belts 117. A complete row 61 of packages 17 can then be provided with a respective label 13 by moving the application elements 115.

After a row of packages 17 has been labeled, the application device 23 can be moved by a drive 25 in the longitudinal direction L to the next row 61 of packages 17, wherein, during this movement or after the movement, further labels 13 can be transferred from the label dispenser 19 to the application device 23 and, after reaching the next row 61, can then be applied to the packages 17 arranged in this row 61. In this way, all the rows 61 can be approached during the cycle pause and the respective packages 17 can be labeled, whereupon the packaging machine M can move the material web 15 in a next cycle and can bring a subsequent format 59 to the labeling station 216.

Conventionally, labeling devices of packaging machines are so-to-say docked at the packaging machine as additional devices, which are to be understood as external with respect to the packaging machine, and are operated as separate units that must be coordinated with the operation of the packaging machine. However, this coordination is often difficult and the attachment of the labeling devices is time-consuming, wherein a poor coordination between the packaging machine and the labeling device can in particular lead to undesirably frequent operating interruptions.

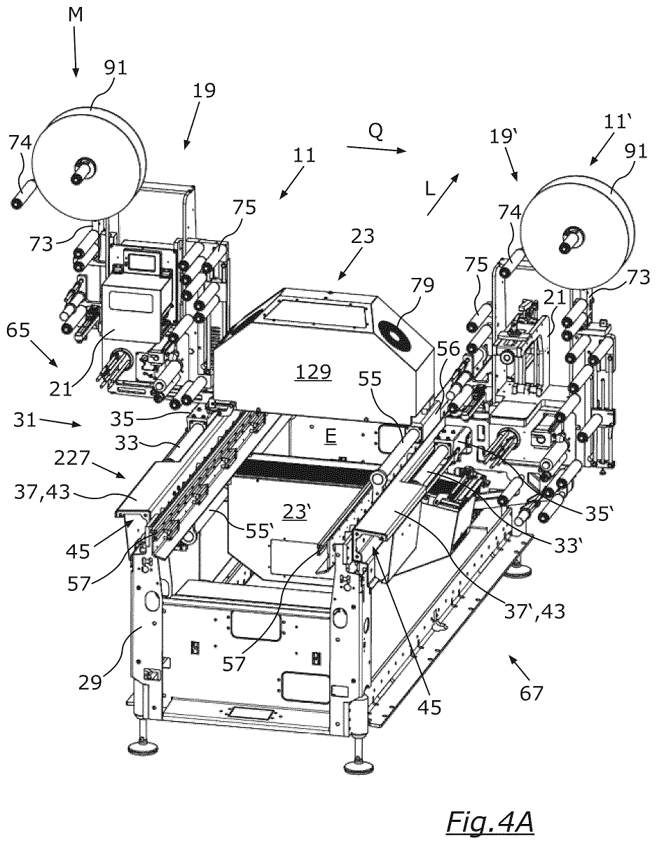

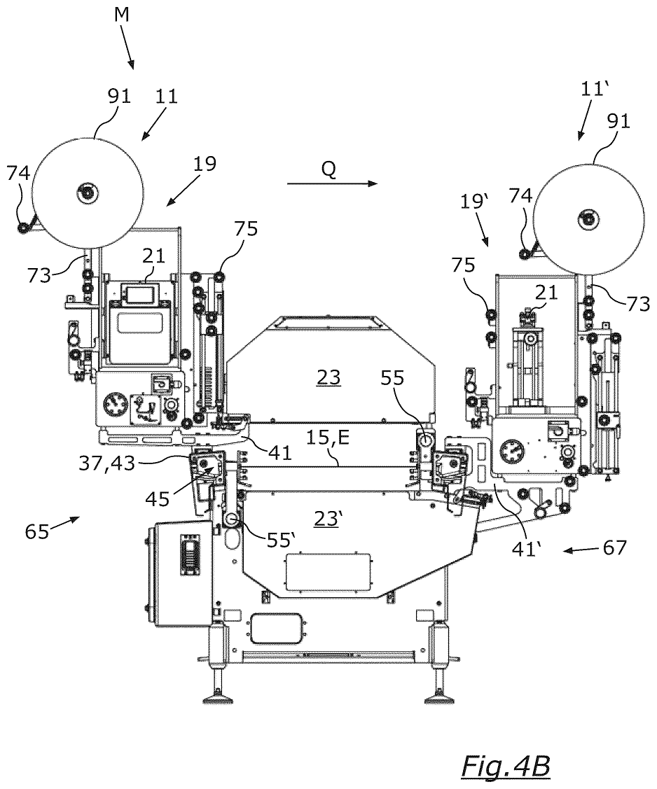

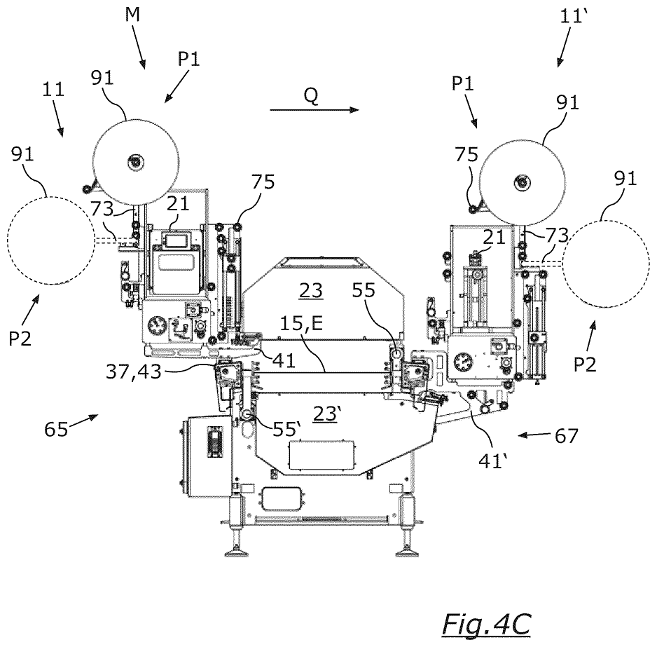

FIGS. 4A to 6B therefore illustrate an embodiment of a packaging machine M in which the labeling devices 11 and 11′, i.e. a labeling device 11 for applying labels 13 to the upper side O and a labeling device 11′ for applying labels 13 to the underside U of a material web 15 moved by the packaging machine M, are an integral part of the packaging machine M and in which in particular a drive 25 or 25′ for moving the respective application device 23 or 23′ in the longitudinal direction L is structurally integrated into a frame 29 of the packaging machine M.

In FIGS. 4A to 4C, the labeling device 11 configured to apply labels 13 to the upper side O is shown at the left-hand side, whereas the second labeling device 11′ provided to apply labels 13 to the underside U is shown at the right-hand side. The left-hand side in the Figures therefore corresponds to the first side 65 of the packaging machine M and the right-hand side in the Figures corresponds to the second side 67 of the packaging machine M.

The labeling devices 11 and 11′ of this embodiment are generally based on the principle explained above with reference to FIGS. 2A and 2B and have a respective label dispenser 19 or 19′ that is configured to provide labels 13 and to transfer them to a respective application device 23 or 23′. Furthermore, both labeling devices 11 and 11′ have a respective printer 21 or 21′. In this embodiment, the label carrier tape 71 not shown in FIGS. 4A to 4C is also guided from a label store 69 or a roll 91 to the application device 23 or 23′ via a plurality of deflection and/or dancer rollers 75.

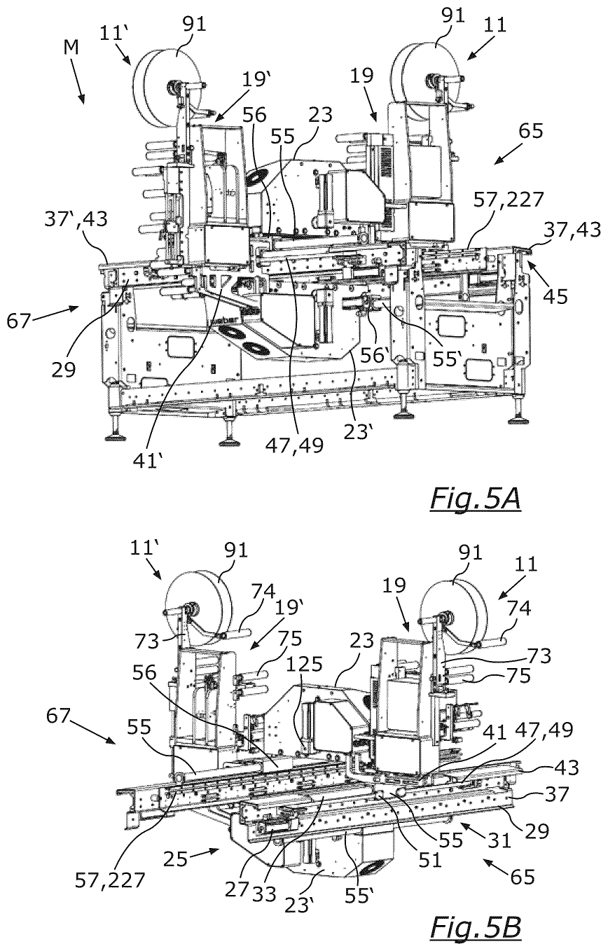

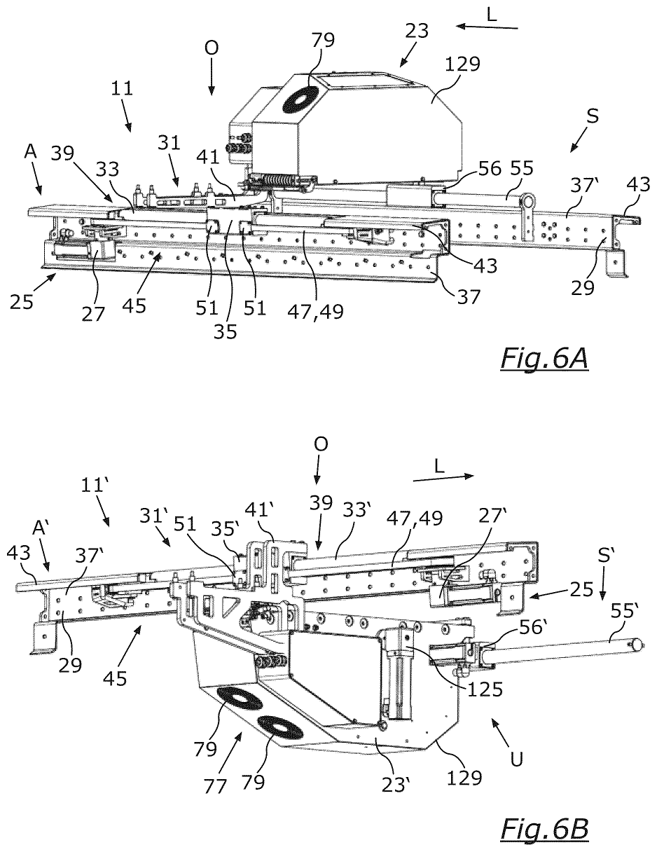

To be able to move the application device 23 in the longitudinal direction L as explained above in connection with FIG. 3, the labeling device 11 has a drive 25 comprising a motor 27. As can be seen, for example, from FIG. 5A and in particular 6A, the motor 27 is held in a stationary manner at the frame 29 of the packaging machine M and the drive 25 is configured to move the application device 23 relative to the motor 27. In particular, the motor 27 is in this respect held outside at the frame 29 at an outer beam 37 of the frame 29. Furthermore, the motor 27 is arranged in an inner space of the beam 37 or of a casing 43 arranged at the beam 37 and is thus protected against access (cf. in this respect also FIGS. 4A to 4C; in FIGS. 5A to 6B, the lateral casing is hidden to better illustrate the arrangement of the motor 27).

The motor 27 is in particular configured as a servomotor and is arranged in a vertical orientation at the beam 37 in order to drive, via a crown gear 53, a coupling element 47, in particular configured as a toothed belt 49, that is likewise arranged in the inner space 45 of the casing 43. The coupling element 47 is interrupted and respective ends of the coupling element 47 are connected via clamping elements 51 to a carriage 35 on which the application device 23 is supported via a connection element 41. By setting the toothed belt 49 into a revolving movement, the carriage 35 and, via it, the application device 23 can therefore be moved in the longitudinal direction L.

Furthermore, the carriage 35 is guided on a guide rod 33 of a guide device 31 of the labeling device 11 that extends in the longitudinal direction L and that is likewise supported at the frame 29 of the packaging machine M. In particular, the casing 43 or the beam 37 has, at the upper side O, an opening 39 in which the guide rod 33 is arranged so that the connection element 41 can be attached to the carriage 35 from above in order to connect the carriage 35 to the application device 23. In addition, in this way, the guide rod 33 can be integrated directly into the casing 43 or the frame 29 of the packaging machine M.

To further achieve a reliable and stable support of the application device 23, the guide device 31 has a further guide rod 55 on a side of the packaging machine M opposite the guide rod 23 in the transverse direction Q, the second side 67, on which further guide rod 55 the application device 23 is supported via a further carriage 56 movable along the further guide rod 55. In this respect, the carriage 56 arranged on the further guide rod 55 only serves to support the application device 23 and is ultimately carried along by the application device 23 during a movement. As can be seen, for instance, from FIGS. 4A and 4B, the further guide rod 55 is also supported at the frame 29 of the packaging machine M, wherein the further guide rod 55 is, however, arranged between a chain guide 57 for moving the material web 15 and a beam 37′ of the frame 29 arranged at the second side 67, whereas the guide rod 33 is arranged at the first side 65 of the packaging machine M directly at the beam 37 or the casing 43. As will be explained in more detail below, this so-to-say enables a mirrored arrangement of the second labeling device 11′ or its application device 23 to also be able to apply labels 13 to the underside U of the provided material web 15.

The guide device 31 of the labeling device 11 thus has a drive side A, at which the motor 27 for driving the carriage 31 is arranged, and a support side S at which the further guide rod 55 is arranged. The drive side A of the first labeling device 11 therefore corresponds to the first side 65 of the packaging machine M and the support side S of the first labeling device 11 corresponds to the second side 67 of the packaging machine M.

The second labeling device 11′ likewise has a drive 25′ for moving the application device 23′ along the longitudinal direction L, said drive also being integrated into the frame 29 of the packaging machine M. This can in particular be seen from FIGS. 5B and 6B.

As in particular FIG. 6B shows, the drive 25′ for moving the application device 23′ of the second labeling device 11′ also has a motor 27′ that is supported at the beam 37′ and that is arranged in an inner space 45 of the beam 37′ or in a casing 43 associated with this beam 37′. The motor 27′, which can likewise be configured as a servomotor, again drives, via a crown gear 53′, a coupling element 47′ or a toothed belt 49′ to be able to move a carriage 35′ via the latter. The carriage 35′ is in turn guided on a guide rod 33′ of a guide device 31′ that extends in the longitudinal direction L and that is arranged in an opening 39 at the upper side O of the beam 37′ or the casing 43. In the labeling device 11′, a connection element 41′, from the upper side O, also engages at the carriage 35′ accessible from there to be able to connect the application device 23′, which is guided below the material web 15 and in particular below the carriage 35′, to the carriage 35′ and thus to be able to move the application device 23′ together with the carriage 35′. For this purpose, the connection element 41′ of the second labeling device 11′ extends laterally outwardly, starting from the carriage 35′, to over the margin of the frame 29 and from there downwardly in order to extend below the beam 37′ to the application device 23′ of the second labeling device 11′. The application device 23′ is again supported on a side of the packaging machine M opposite the guide rod 31′ by a further guide rod 55′ on which a carriage 56′ that is movable together with the application device 23′ is guided.

The labeling device 11′ also has a drive side A′, at which the motor 27′ is arranged, and a support side S′ at which the further guide rod 55′ is arranged. However, as can, for example, be seen from FIGS. 4A to 4C, on an attachment of the labeling devices 11 and 11′ to the packaging machine M, the drive side A′ and the support side S′ are so-to-say interchanged with respect to the drive side A and the support side S of the labeling device 11 so that the drive side A′ of the second labeling device 11′ is arranged at the second side 67 of the packaging machine M and the support side S′ of the second labeling device 11′ is arranged at the first side 65 of the packaging machine M. As can further in particular be seen from FIG. 4B, in the second labeling device 11′, the guide rod 33′ is also arranged directly at the beam 37′, whereas the further guide rod 55′ is arranged between the beam 37 and the chain guide 57 so that a mirrored arrangement, so to speak, of the drives 25 and 25′ for the application devices 23 and 23′ results.

Since the application device 23 and 23′ of the labeling device 11 and 11′ can thus be moved relative to the respective motor 27 or 27′, the respective motor 27 or 27′ does not have to be carried along when moving the application devices 23 and 23′, which enables a faster movement of the application devices 23 and 23′. The integration of the drives 27 and 27′ into the frame 29 of the packaging machine M furthermore enables access protection and a fixed arrangement of the labeling device 11 and 11′ within the packaging machine M. Furthermore, it can, for instance, be seen from FIGS. 4A and 4B that the movable components of the drives 27 and 27′ are substantially covered by the casing 43 and are thus protected from access. In addition, the drives 27 and 27′ of the labeling device 11 and 11′ are arranged substantially below a plane E in which the material web 15 is guided by the chain guide 57.

Furthermore, in addition to the application devices 23 and 23′, the respective label dispensers 19 and 19′ of the labeling devices 11 and 11′ are also connected to the respective carriage 35 or 35′ via the respective connection element 41 or 41′ so that the drives 27 and 27′ of the labeling devices 11 and 11′ are configured to move the respective label dispensers 19 in the longitudinal direction L and in particular relative to the respective motor 27 or 27′. This can in particular enable an orderly transfer of labels 13 to the application device 23 or 23′ in any position of the application device 23 or 23′ with respect to the longitudinal direction L.

In addition, FIG. 4C illustrates that the respective label store 69 of the label dispensers 19 or 19′ of the labeling devices 11 and 11′, in which the roll 91 is inserted, can be moved between a first position Pl and a second position P2. For this purpose, the roll 91 is held at a holding arm 73 that can be pivoted via a handle 74 to move the label store 69 between the first position Pl and the second position P2.

In particular, the label store 69 is in this respect arranged higher in the position Pl than in the second position P2, whereas, in the second position P2, the label store 69 is spaced further apart from the application device 23 and the frame 29 of the packaging machine M in the horizontal direction and projects further laterally into the space in the horizontal direction.

The second position P2 can generally be provided to change the roll 91 as comfortably as possible, whereas, by moving the label store 69 into the first position P1, the space to the side of the packaging machine M can be kept as free as possible. Conventionally, it is necessary to always move the label store 69 into the first position P1 in order to transfer labels 13 to the application device 23 or 23′ and to be able to operate the labeling devices 11 and 11′.

In embodiments of the labeling devices 11 and 11′ disclosed herein, it is, however, provided that the label dispenser 19 or 19′ is configured to transfer labels 13 to the application device 23 or 23′ both in the first position P1 and in the second position P2, wherein in particular a compensation of the changed guidance of the label carrier tape 71 by the deflection and/or dancer rollers 75 can take place for this purpose. In particular, a flexible handling of the labeling devices 11 and 11′ can hereby be achieved since a person operating the labeling devices 11 and 11′ does not have to switch between the positions P1 and P2 to be able to perform certain tasks, but can rather select a respective preferred position P1 or P2 in which the labeling device 11 or 11′ is operated. Furthermore, in some embodiments, it can also be provided that the label dispenser 19 or 19′ is configured to transfer labels 13 to the application device 23 when the label store 69 is arranged in any desired position between the first position Pl and the second position P2 that can in particular represent respective end positions with respect to the movability of the label store 69.

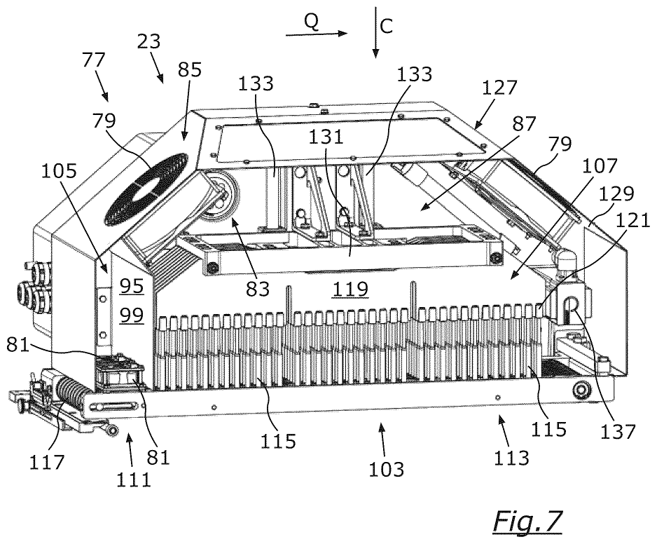

FIG. 7 further shows a perspective view of the application device 23 of the first labeling device 11, wherein a housing 129 of the application device 23 is shown transparent. The application device 23′ is basically identical in design so that the following explanations apply in the same way to the application device 23′ of the second labeling device 11′.

As FIG. 7 shows, the application device 23 has a plurality of mutually offset belts 117 for transporting labels 13 in the transverse direction Q that can then be applied to the material web by means of application elements 115 engaging through belts 117 disposed next to one another and spaced apart from one another. The application elements are in this respect arranged by respective latching connections 121 at metal sheets 119 that are offset from one another in the longitudinal direction L of the packaging machine M and that can be moved together in the vertical direction C by a carriage 131 guided via guide rods 133.

Furthermore, the application device 23 has the aforementioned vacuum device 77, wherein the vacuum device 77 in particular comprises two fans 79 that are arranged at an outer side 127 of the housing 129 and that are configured to generate a negative pressure U in an application section 113 of the application element 123 in which the application elements 115 are arranged. In particular, the fans 79 are in this respect provided to generate a negative pressure at the application section 113 over a relatively large area and are therefore arranged relatively far away from the belts 117, and the labels 13 transported there, at a roof section of the housing 127.

Furthermore, in the embodiment shown, the vacuum device 77, however, has two further fans 81 that are arranged directly in the vicinity of the belts 117 in a takeover section 111 of the application device 23 in which the labels 13 are taken over from the label dispenser 19. The takeover section 111 is separated from the application section 113 by a separating element 99, which extends in the inner space 87 of the housing 129, so that any air flow between the takeover section 111 and the application section 113 is prevented. In this regard, the separating element 99 divides the housing 129 into two chambers 105 and 107, wherein the chamber 105 comprises the takeover section 111 and the chamber 107 comprises the application section 113.

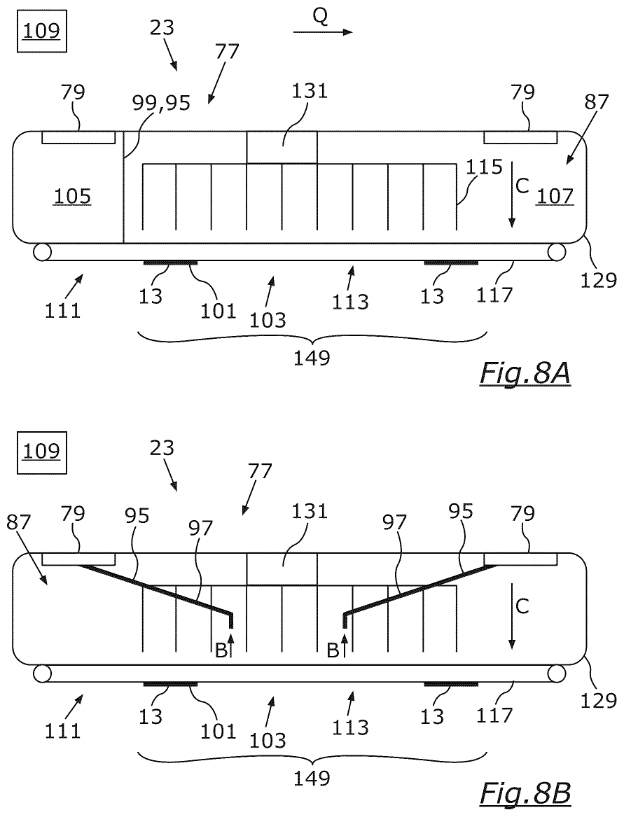

Since the vacuum device 77 has separate fans 81 for the takeover section 111, the vacuum device 77 is configured to spatially vary the strength of the negative pressure generated in the inner space 87 of the application device 23 and in particular to increase it in the region of the takeover section 111 in order to achieve a safe takeover of the labels from the label dispenser 19. In the application section 113, on the other hand, a large-area negative pressure that is, however, less strong compared to the negative pressure in the takeover section 111 can be generated by the fans 79. Furthermore, a control device 109 not shown in FIG. 7 can, for example, be configured to individually control the fans 79 and/or 81 to influence an air flow developed by the respective fan 79 or 81 and, as a result, to influence the negative pressure generated by the respective fan 79 or 81 (cf. also FIGS. 8A and 8B). The control device 109 can in particular be a component of the control device 241 of the packaging machine M.

FIGS. 8A and 8B illustrate further embodiments of an application device 23 comprising a vacuum device 77 that is configured to generate a variable negative pressure in the inner space 87 of the application device 23.

In the embodiment according to FIG. 8A, a guide element 95 acting as a separating element 99 is provided that divides the inner space 87 of the application device 23 or its housing 129 into two chambers 105 and 107. The application device 23 only has the two fans 79 at the outer side 127 of the housing 129, wherein, due to the different size of the chambers 105 and 107, a stronger negative pressure can, however, be generated in the takeover section 111 associated with the chamber 105 than in the application section 113 associated with the chamber 107. Furthermore, it can also be provided that the guide element 95 can be moved, in particular by the control device 109, to be able to further vary the negative pressure.

In the embodiment according to FIG. 8B, respective intake nozzles 97 acting as guide elements 95 are connected to the fans 79 and can likewise in particular be movable. An air flow developed by the fans 79 can be deflected through these intake nozzles 97, in particular at the center of the inner space 87 of the application device 23, such that the air flow B is oriented perpendicular to a surface of extent 101 along which the taken-over labels 13 extend. In particular, a stable suction can thereby be achieved. For example, the intake nozzles 97 can be settable and/or adjustable before a start of operation, wherein, alternatively or additionally thereto, it can also be provided that the intake nozzles 97, and thus the guide elements 95 of the embodiment shown, can be moved during the operation by the control device 109.

The control device 109 can generally also be configured to individually control the fans 79, for example, to be able to increase the negative pressure on a takeover of labels 13 and to be able to reduce it on an application of labels 13 to the material web 15. This can, for example, be achieved by intentionally adjusting a strength of the air flows developed by the fans 79 and/or 81 and also by switching the fans 79 and/or 81 on or off.

FIGS. 9A and 9B furthermore illustrate a drive 123 for moving the application elements 115 along the vertical direction C. As FIG. 9A shows, this drive 123 has a servomotor 125 supported at an outer side 127 of the housing 129, wherein FIG. 9B illustrates that this servomotor 125 drives a belt 135 arranged in the inner space 87 of the housing 129, for which purpose a motor shaft of the servomotor 125 extends into the inner space 87. By means of the belt 135, the carriage 131, which is arranged in the inner space 87 and at which the application elements 115 are supported, can again be moved in the vertical direction C. Thus, the application elements 115 can be moved without having to provide installation space in the inner space 87 for the servomotor 127.

FIG. 10 further illustrates a drive 135 for driving the belts 117 of the application device 23 by which received labels 13 can be transported in the transverse direction Q. This drive 135 also has a servomotor 137, wherein the servomotor 137 is, however, arranged in the inner space 87 of the housing 129 of the application device 23. The servomotor 137 in this respect extends along the longitudinal direction L along which the packaging machine M moves the material web 15 so that a narrow configuration and arrangement of the servomotor 137 with respect to the transverse direction Q can be achieved. The servomotor 137 drives a toothed belt 141 via a crown gear 145, which toothed belt 141 is in turn connected to a shaft 143 for driving the belts 117. In this regard, a compact and simple design of the drive 135 can be achieved, wherein both the servomotor 125 and the servomotor 137 enable a precise control and/or regulation of the movements of the application elements 115 and/or the belts 117.

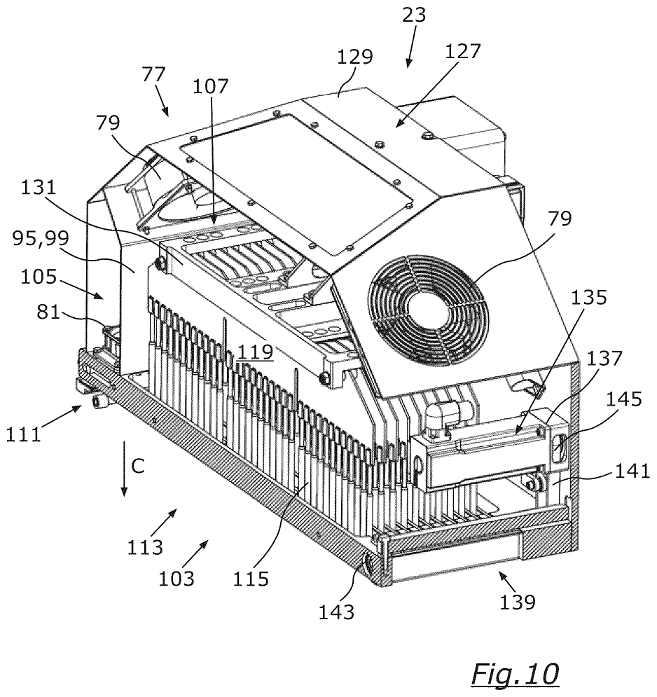

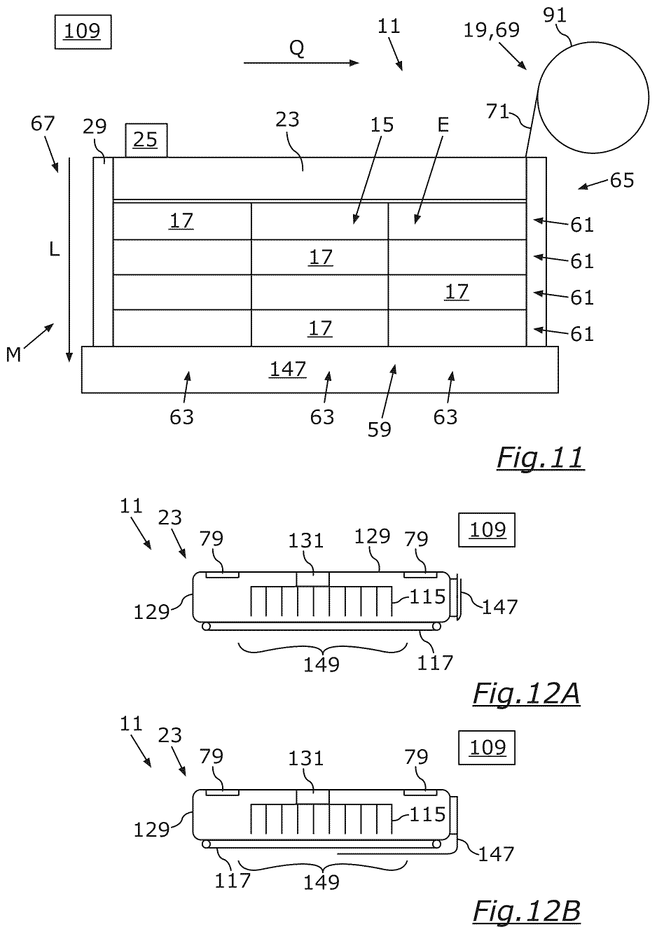

FIG. 11 again illustrates, in a schematic plan view, an embodiment of a packaging machine M and a labeling device 11 whose application device 23 is configured to selectively apply labels 13 received from a label dispenser 19 to a material web 15 or to transfer them to a sorting-out element 147. In the embodiment shown, the sorting-out element 147 is supported at the frame 29 of the packaging machine M, bridging the material web 15, wherein the application device 23 can be selectively movable into the region of the sorting-out element 147 by the drive 25 to be able to apply labels 13 to the sorting-out element 147. In particular, the sorting-out element 147 can be flat and can be attached in the immediate vicinity of the material web 15 so that the application of the labels 13 to the sorting-out element 147 can take place almost identically to the application of the labels 13 to the material web 15 and slight differences in the distance to be covered by the application elements 115 can be compensated for by a yielding, in particular resilient, attachment of the application elements 115 to the carriage 131 or the metal sheets 119.

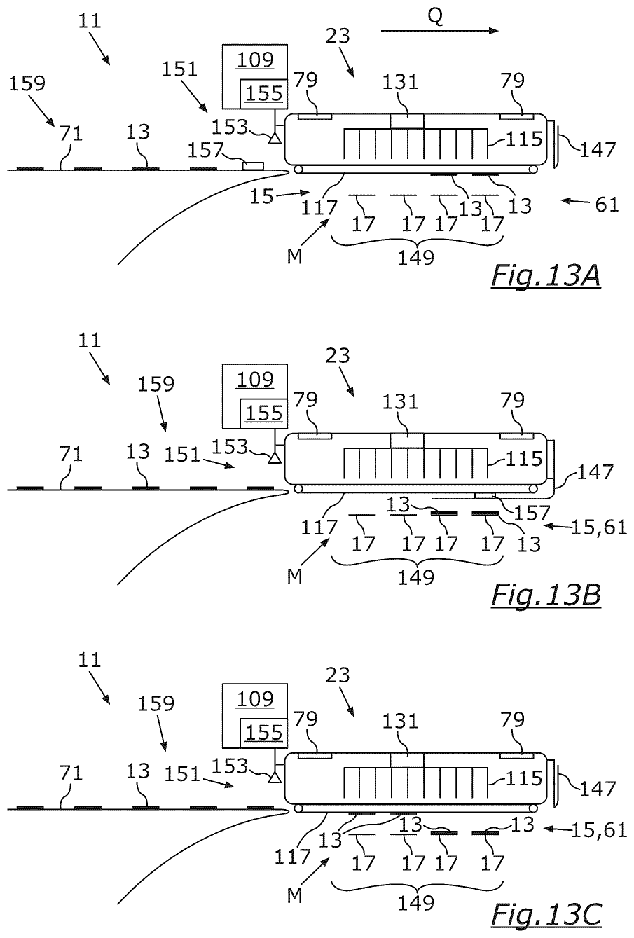

For example, it can be provided to apply any defective labels 157 (cf. FIGS. 13A to 13C) to the sorting-out element 147 in order to avoid an application of defective labels 157 to packages 17 that must lead to a rejection of the package 17. Therefore, if it is determined that a defective label 157 has been transferred to the application device 23, the application device 23 can be moved in the longitudinal direction L to the sorting-out element 147. In particular, the packaging machine M and/or the labeling device 11 can for this purpose have a monitoring device 115 that is configured to recognize defective labels 157, as will be explained below. Here, too, such a sorting out of defective labels can be provided for both the labeling device 11 and the labeling device 11′ in basically the same implementation.

FIGS. 12A and 12B illustrate an embodiment of a labeling device 11 that has an application device 23 with an integrated sorting-out element 147. As FIG. 12A shows, the sorting-out element 147 can generally be arranged outside the working region 149 of the application device 23 so that the application device 23 can apply received labels 13 to the material web 15. However, if a label 13 is to be transferred to the sorting-out element 147, the sorting-out element 147 can, as FIG. 12B shows, be moved into the working region 149 of the application device 23 so that a label 13 can be applied to the sorting-out element 147 by the application device 23. For this purpose, the sorting-out element 147 can, for example, be foldable, pivotable, pushable or of a lamellar design and rollable, wherein an actuation of the sorting-out element 147 can, for example, take place pneumatically and/or by an electric motor provided for this purpose. In particular, the sorting-out element 147 can be controllable by a control device 109 of the labeling device 11 and/or of the packaging machine M.

FIGS. 13A to 13C further illustrate a possible method that can be carried out when a defective label 157 is detected. For this purpose, the shown embodiment of the labeling device 11 first comprises the aforementioned monitoring device 151 that comprises a camera 153 that is attached to the application device 23 and that can be moved together with the application device 23. Furthermore, the monitoring device 51 comprises an image evaluation device 155 as part of the control device 109 that is configured to evaluate images generated by the camera 153 of the labels 13 to be transferred. The camera 153 can be configured to record labels 13 moved from the label dispenser 19 to the application device 23 and to generate monitoring images, wherein the image evaluation device 155 can be configured to compare the generated monitoring images with reference images or comparison images of correct labels 13 that can be stored in the image evaluation device 155 to be able to identify a defective label 157 through this comparison.

As FIG. 13A illustrates, labels 13 can be transferred from a label stream 159 generated by the label dispenser 19 to the application device 23 until the defective label 157 would have to be transferred to the application device 23. The transfer of the defective label 157 can then be delayed and the application device can move the labels 13 in the transverse direction Q to respective packages 17, which are provided in a row 61, and can apply them to the packages 17 (cf. also FIG. 13B).

After the taken-over labels 13 have been applied to the packages 17, the defective label 157 can be transferred to the application device 23. Furthermore, the sorting-out element 147 can be brought into the working region 149 of the application device 23, whereupon the application device 23 can transfer the defective label 157 to the sorting-out element 147 by moving the application elements 115 and can in particular apply said defective label 157 to the sorting-out element 147. Alternatively thereto, in corresponding embodiments, such as the embodiment illustrated in FIG. 11, the application device 23 can, for example, also be moved to a sorting-out element 147 supported at the packaging machine M in order to transfer the defective label 157 there.

After the transfer of the defective label 157, the sorting-out element 147 can be moved out of the working region 149 again and two further labels 13 can be transferred to the application device 23 to then be able to apply them to the remaining two packages 17 in the row 61. After the defective label 157 has been sorted out in this way and the row 61 has been completely labeled, a number of labels 13 corresponding to the number of packages 17 per row 61 can again be transferred to the application device 23 until the next defective label 157 is recognized and the above-explained procedure can be repeated. In this way, individual defective labels 157 can be sorted out with only a small loss of time and an application of defective labels 157 to packages 17 can be avoided.

FIGS. 14A and 14B illustrate a further embodiment of a labeling device 11 that can, for example, be used in a packaging machine M according to any one of the above-explained embodiments or can form a part of such a packaging machine M. As FIG. 14A shows, in this embodiment of the labeling device 11, a label dispenser 19 is also provided that has a label store 69 in which a label carrier tape 71 wound up into a roll 91 is arranged. Labels 13 are applied to the label carrier tape 71 and the label dispenser 19 is configured to transfer the labels 13 to an application device 23. As has likewise already been explained above, the application device 23 is configured to apply the labels 13 taken over from the label dispenser 19 to the provided material web that is not shown in FIG. 14A. For this purpose, a plurality of application elements 115 movable in the vertical direction C are again provided at the application device 23 and engage between belts 117 for moving the labels 13 to be able to release the labels 13 from the belts 117 and apply them to the material web.

In contrast to the embodiments explained above, in the labeling device 11 illustrated by means of FIGS. 14A and 14B, a discarding device 161 is further provided that is configured to selectively prevent the transfer of a label 158 to be discarded to the application device 23.

According to the embodiment illustrated by means of FIGS. 14A and 14B, the discarding device 161 for this purpose has a deflection contour 163 that is connected to the application device 23 by a drive arm 181 so that the application device 23 comprises the discarding device 161 in the embodiment shown. In FIG. 14A, the discarding device 161 is shown in a passive position Y, in which the discarding device 161 is not in active contact with the label carrier tape 71, so that labels 13 can be released from the label carrier tape 71 in the form explained above by a guidance over a transfer edge 89 and can be transferred to the application device 23 to then be applied to the material web.

As FIG. 14B shows, the discarding device 161 or the deflection contour 163 can, however, be moved into a discarding position Y′, in which the deflection contour 163 comes into contact with a label 158 to be discarded in the region of the transfer edge 89 at which the labels 13 to be applied to the material web are released from the label carrier tape 71. Due to this contact, the label 158 to be discarded is so-to-say caught between the label carrier tape 71 and the deflection contour 163 so that a release of the label 158 from the label carrier tape 71 can be prevented and the label 158 to be discarded cannot be transferred to the application device 23, but can be discarded. For this purpose, the label 158 to be discarded can in particular be guided on the label carrier tape 71 around the deflection edge 89 and can therefore also still be located at the label carrier tape 71 downstream of the transfer edge 89 in order, for example, to be able to be disposed of together with the label carrier tape 71 after the label carrier tape 71 has been used up.

Provision can in particular be made to identify the aforementioned defective labels 157 as labels 158 to be discarded and therefore not to transfer them to the application device 23 so that the defective labels 157 can in particular form labels 148 to be discarded. Therefore, in the embodiments explained with reference to FIGS. 14A and 14B and in the embodiments explained below with reference to FIGS. 15A to 18B, a monitoring device 151 that is not shown in these Figures but is in particular explained above in connection with FIGS. 13A and 13C and that comprises a camera 153 and an image evaluation device 155 can also be provided to detect defective labels 157 or labels 158 to be discarded. Furthermore, a control device 109 of the labeling devices 11 illustrated by means of FIGS. 14A to 18B can likewise be configured to control the discarding device 161 in dependence on a signal of the monitoring device 151 and in particular to move it from the passive position Y into the discarding position Y′ in order to prevent a transfer of defective labels 157 or labels 158 to be discarded to the application device 23 (cf. also with respect to the control device 109, in particular FIGS. 13A to 13C).

As can be seen from the combined view of FIGS. 14A and 14B, in the embodiment illustrated there, the application device 161 can be moved from above the transfer edge 89 from the passive position Y into the discarding position Y′. In particular, the discarding device 161 can be transferrable into the discarding position Y′ by a combined pivot and extension movement of the drive arm 181.

In a further embodiment according to FIG. 15A, on the other hand, it is provided that the passive position Y is a lower position so that, as FIG. 14B illustrates, the discarding device 161 can be movable with the deflection contour 163 from below the transfer edge 89 from the passive position Y into the discarding position Y′. In the embodiment shown there, a pressure element 165 preloaded by a spring 167 towards the label carrier tape 71 is furthermore provided and is configured, in the discarding position Y′, to develop a pressure on the label 158 to be discarded as FIG. 15B shows. In particular, the pressure element 165 is in this respect arranged such that the pressure element 165 develops a pressure on a downstream part of the label 158 to be discarded while the label 158 to be discarded is partly still located upstream of the transfer edge 89. Furthermore, the pressure element 165 can in particular be configured as a pressure roller.

As an alternative to such a preloaded pressure element 165, provision can also be made according to the embodiment illustrated by means of FIGS. 18A and 18B that the discarding device 161, and in particular the deflection contour 163, has a compressed air device 169 that is configured, in the discarding position Y′, to generate a compressed air flow on the label 158 to be discarded in order, as a result, to press the label 158 to be discarded against the label carrier tape 71 and to prevent a release of the label 158 to be discarded from the label carrier tape 71. The skilled person understands that such a pressure element 165 or a compressed air device 169 can also be provided in a discarding device 161 positioned in the passive position Y above the transfer edge 89 or in connection with deflection contours 163 of discarding devices 161 arranged in such a manner.

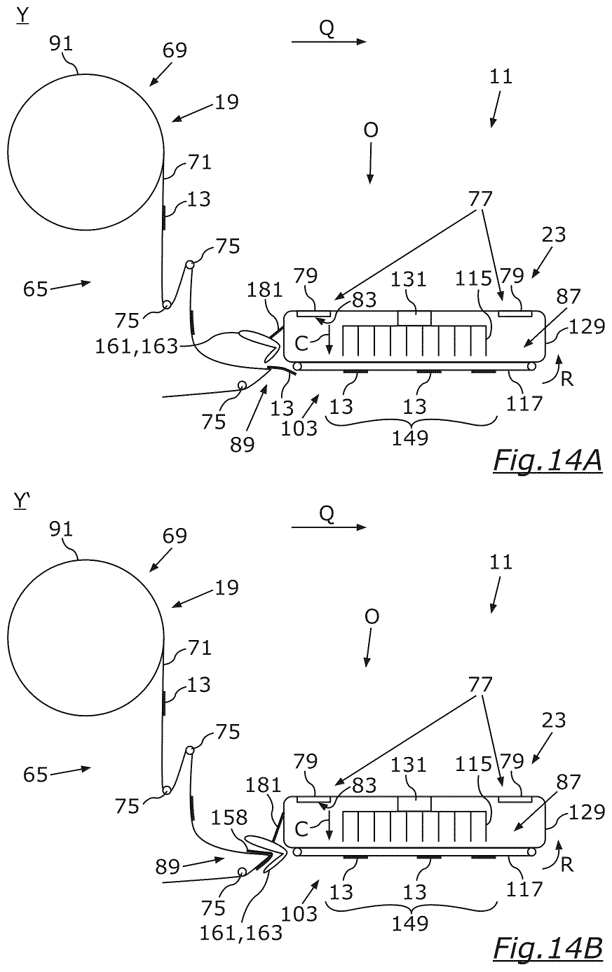

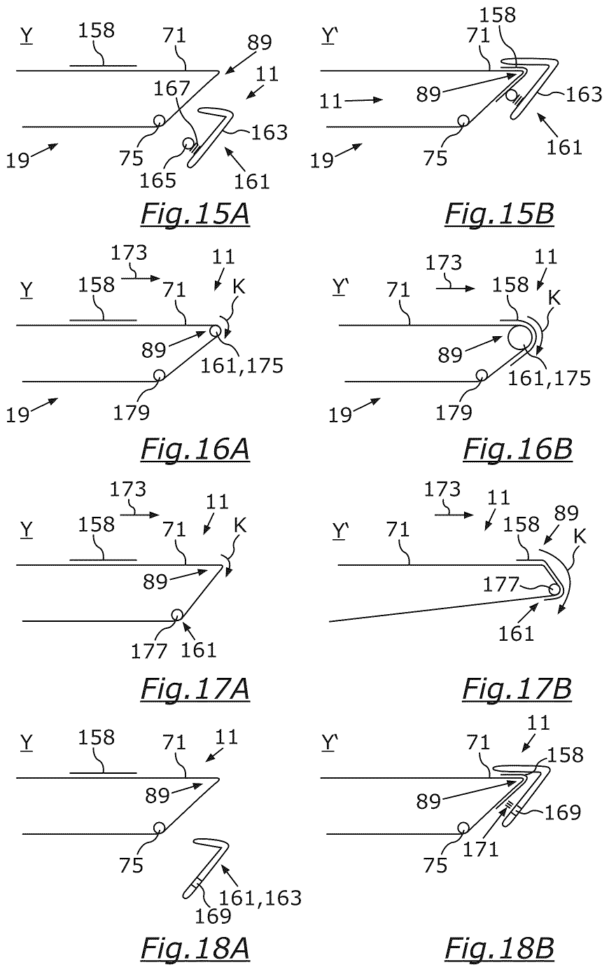

FIGS. 16A and 16B illustrate a further embodiment of a labeling device 11 comprising a discarding device 161, wherein this discarding device 161 is configured to change label 158 to be discarded. As can be seen from FIGS. 16A and 16B, the discarding device 161 for this purpose comprises an inflatable discarding element 175 that forms a deflection for the label carrier tape 71 at the transfer edge 89. By inflating the inflatable element 175, a curvature K of the path 173 of the label carrier tape 71 at the transfer edge 89 can be reduced or a radius of the path 173 at the deflection edge 89 can be increased so that the label carrier tape 71 at the transfer edge 89 in the discarding position Y′ is so-to-say guided over a less pointed edge and the label 158 to be discarded is therefore not released from the label carrier tape 71. To enable the change of the path 173, a compensating element 179 is furthermore provided that can, for example, be configured as a dancer roller.

In the embodiment according to FIG. 17A, it is provided that the discarding device 161 comprises a deflection element 177 and is configured to change a path 173 of the label carrier tape 71 by moving the deflection element 177. Due to such a movement of the deflection element 177, a curvature K of the path 173 can also be reduced in the region of the transfer edge 89 in order, as a result, to prevent a release of the label 158 to be discarded from the label carrier tape 71.

In principle, in all the illustrated discarding devices 161, it can be provided that the respective discarding device 161 can be moved into the discarding position Y′ and/or into the passive position Y by a pneumatic drive and/or an electric motor. Furthermore, it can, for example, be provided that the discarding device 161 is preloaded into the discarding position Y′ and can selectively be moved against the preload by a drive into the passive position Y and can be held there in order to enable a transfer of the labels 13 to the application device 23.

### REFERENCE NUMERAL LIST

11 first labeling device
11′ second labeling device
13 label
15 material web
17 package
19 label dispenser
19′ label dispenser
21 printer
23 application device
23′ application device
25 drive for the application device
25′ drive for the application device
27 motor
27′ motor
29 frame
31 guide device
31′ guide device
33 guide rod
33′ guide rod
35 carriage
35′ carriage
37 beam
37′ beam
39 opening
41 connection element
41′ connection element
43 casing
45 inner space of the casing
47 coupling element
47′ coupling element
49 belt
49′ belt
51 clamping element
51′ clamping element
53 crown gear
53′ crown gear
55 further guide rod
55′ further guide rod
56 carriage
56′ carriage
57 chain guide
59 format
61 row
63 track
65 first side
67 second side
69 label store
71 label carrier tape
73 holding arm
74 handle
75 deflection roller and/or dancer roller
77 vacuum device
79 fan
81 fan
83 suction side
85 pressure side
87 inner space of the application device
89 transfer edge
91 roll
93 discharge roll
95 guide element
97 intake nozzle
99 separating element
101 surface of extent
103 working side
105 chamber
107 chamber
109 control device
111 takeover section
113 application section
115 application element
117 belt for moving the labels
119 metal sheet
121 latching connection
123 drive for the application elements
125 servomotor
127 outer side
129 housing
131 carriage
133 guide rod
135 belt
135 drive for the belts of the application device
137 servomotor
139 end section
141 toothed belt
143 shaft
145 crown gear
147 sorting-out element
149 working region
151 monitoring device
153 camera
155 image evaluation device
157 defective label
158 label to be discarded
159 label stream
161 discarding device
163 deflection contour
165 pressure element
167 spring
169 compressed air device
171 compressed air flow
173 path
175 discarding element
177 deflection element
179 compensating element
181 drive arm
210 food product
211 molding station
211a top tool of the molding station
211b bottom tool of the molding station
213 insertion station
213A conveyor belt
213B conveyor belt
214 feed station
215 sealing station
215a upper part of the sealing station
215b lower part of the sealing station
216 labeling station
217 separating station (transverse direction)
219 separating station (longitudinal direction)
221 package
223 bottom material web
223A supply roll
225 top material web
225a supply roll
227 transport device (transport chain for the bottom material web)
229 recess
241 control device
243 sealing seam
245 operating unit
247 machine frame
250 robot
A drive side
A′ drive side
B air flow
C vertical direction
E plane of the material web
K curvature
L longitudinal direction
M packaging machine
O upper side
P1 first position
P2 second position
Q transverse direction
R direction
S support side
S′ support side
U underside
Y passive position
Y′ discarding position

1-102. (canceled)

103. A labelling device for applying labels to a material web that is moved along a longitudinal direction by a packaging machine in order to produce packages for food products, comprising:
an application device for applying the labels to the material web; and
a label dispenser configured provide the labels and transfer the labels to be applied to the application device, the label dispenser comprising:
a label store, into which a label carrier tape rolled up into a roll is insertable, on which label carrier tape the labels to be transferred to the application device are provided,
wherein the label store is movable into a first position and into a second position that differs from the first position, and
wherein the label dispenser is configured to transfer the labels to the application device both when the label store is positioned in the first position and when the label store is positioned in the second position.

104. The labelling device of claim 103,
wherein the roll is replaceable with a new roll of a rolled-up label carrier tape both in the first position of the label store and in the second position of the label store.

105. The labelling device of claim 103,
wherein, in the second position, the label store is arranged in at least one of:
lower than in the first position; or
further away from the application device in a horizontal direction than in the first position.

106. The labelling device of claim 103,
wherein the first position and the second position represent respective end positions with respect to a movability of the label store that is movable between the first position and the second position, and
wherein the label dispenser is configured to transfer the labels to the application device in each position of the label store between the first position and the second position.

107. The labelling device of claim 103,
wherein the label store is pivotable between the first position and the second position.

108. The labelling device of claim 107,
wherein the label store is pivotable about a horizontal pivot axis between the first position and the second position.

109. The labelling device of claim 103,
wherein the label dispenser has a pivotable holding arm, and
wherein the label store is movable between the first position and the second position by pivoting the pivotable holding arm.

110. The labelling device of claim 103,
wherein the label carrier tape is guided to the application device via a plurality of at least one of deflection or dancer rollers.

111. A packaging machine for packaging food products, comprising:
a transport device that is configured to move a material web along a longitudinal direction in order to produce packages, and
a labelling device for applying labels to a material web that is moved along a longitudinal direction by a packaging machine in order to produce packages for food products, comprising:
an application device for applying the labels to the material web; and
a label dispenser configured provide the labels and transfer the labels to be applied to the application device, the label dispenser comprising:
a label store, into which a label carrier tape rolled up into a roll is insertable, on which label carrier tape the labels to be transferred to the application device are provided,
wherein the label store is movable into a first position and into a second position that differs from the first position, and
wherein the label dispenser is configured to transfer the labels to the application device both when the label store is positioned in the first position and when the label store is positioned in the second position.

112. A labelling device for applying labels to a material web that is moved along a longitudinal direction by a packaging machine in order to produce packages for food products, comprising:
a label dispenser for providing the labels,
wherein the label dispenser is configured to provide the labels on a label carrier tape and to transfer the labels to an application device; and
the application device for applying the labels to the material web,
wherein the application device has a vacuum device that is configured to generate a negative pressure in an inner space of the application device for sucking the labels onto a working side of the application device,
wherein the vacuum device is configured to vary a strength of the negative pressure generated in the inner space at least one of spatially or temporally.

113. The labelling device of claim 112,
wherein the vacuum device has at least one fan having a suction side disposed in the inner space of the application device and a pressure side disposed outside the inner space of the application device.

114. The labelling device of claim 113,
wherein at least one guide element for a targeted guiding of an air flow generated by the at least one fan in the inner space is arranged in at least one of the inner space of the application device or a region of the suction side of the at least one fan.

115. The labelling device of claim 114,
wherein the at least one guide element or at least a part thereof is movable.

116. The labelling device of claim 114,
wherein the at least one guide element is arranged to deflect the air flow generated by the at least one fan such that the air flow at the working side of the application device is oriented substantially perpendicular to a surface of extent of the labels.

117. The labelling device of claim 114,
wherein the inner space is divided into at least two chambers by the at least one guide element, and
wherein the strength of the negative pressure generated by the vacuum device in the at least two chambers differs.

118. The labelling device of claim 112,
wherein the labelling device has a control device, and
wherein the control device is configured to control the vacuum device to change the strength of the negative pressure.

119. The labelling device of claim 118,
wherein the vacuum device has a plurality of fans for generating the negative pressure, and
wherein the control device is configured to individually control the plurality of fans to change an air flow generated by a respective fan of the plurality of fans.

120. The labelling device of claim 118,
wherein the control device is configured to control the vacuum device to at least one of:
increase the strength of the negative pressure on a taking over of the labels, or
reduce the strength of the negative pressure on an application of the labels to the material web.

121. The labelling device of claim 112,
wherein the vacuum device is configured to generate an increased negative pressure in a takeover section of the application device, the takeover section facing a transfer edge.

122. The labelling device of claim 121,
wherein a separating element is arranged in the inner space of the application device and prevents an exchange of air between the takeover section and an application section of the application device, the application section adjoining the takeover section.

123. The labelling device of claim 121,
wherein the vacuum device has at least one fan arranged in the takeover section for generating the increased negative pressure.

124. The labelling device of claim 123,
wherein at least one further fan for generating a negative pressure is arranged in an application section of the application device.

125. A packaging machine for packaging food products, the packaging machine comprising
a transport device that is configured to move a material web along a longitudinal direction in order to produce packages, and
a labeling device for applying labels to the material web, comprising:
an application device for applying the labels to the material web and comprising a vacuum device that is configured to generate a negative pressure in an inner space of the application device for sucking the labels onto a working side of the application device,
wherein the vacuum device is configured to vary a strength of the negative pressure generated in the inner space at least one of spatially or temporally; and
a label dispenser for providing the labels,
wherein the label dispenser is configured to provide the labels on a label carrier tape and to transfer the labels to the application device.
